(19) United States
(12) Patent Application Publication
(10) Pub. No.: US 2022/0198879 A1
(43) Pub. Date: Jun. 23, 2022

(54) METHOD AND SOCIAL MEDIA PLATFORM FOR SPORTS FANS AND VIDEO GAMERS FOR COMMUNITY WAGERING IN A WIDE VARIETY OF COMPETITIVE ENVIRONMENTS

(71) Applicant: Lazell Brown, Cedar Park, TX (US)

(72) Inventor: Lazell Brown, Cedar Park, TX (US)

(21) Appl. No.: 17/409,678

(22) Filed: Aug. 23, 2021

Related U.S. Application Data
(60) Provisional application No. 63/136,021, filed on Jan. 11, 2021.
(60) Provisional application No. 63/064,469, filed on Aug. 12, 2020.

(51) Int. Cl. G07F 17/32; G06Q 20/38; G06Q 50/34

(52) U.S. Cl. CPC G07F 17/3279; G07F 17/3239; G06Q 50/34; G07F 17/3288; G06Q 20/381; G07F 17/323

(57) ABSTRACT

A system and platform facilitating personal wagers is described. The platform is configured to facilitate betting between players as selected by the player, either for fun, or for actual currency as converted to Green DittoMares, an in-platform currency. The bets are self-governed by the players, and as such, the players themselves must agree on the winning player in order for winnings to be awarded. A rating system enables the winner to rate the opposing player in accordance with his/her compliance and sportsmanship. A chat feature facilitates communication between players.

### CONTINUITY

This application is a non-provisional application of provisional patent application No. 63/136,021, filed on Jan. 11, 2020 and provisional patent application No. 63/064,469, filed on Aug. 12, 2020, and priority is claimed thereto.

### FIELD OF THE PRESENT INVENTION

The present invention relates to the field of network-connected gaming, and more specifically relates to a platform and method for hosting and executing personal wagers between users without directly necessitating the event or game on which the wager is placed, and requiring users themselves to determine the winner of the wagers made.

### BACKGROUND OF THE PRESENT INVENTION

Placing wagers on sports, events, actions, and the like are commonplace among friends, even if they are simple friendly wagers. Sometimes, actual currency is not even necessary, as the simple act of betting a friend raises the stakes, and therefore the shared interest, in the sport or activity. Conventionally, these wagers are placed in-person, between two or more individuals who are witnessing the same event. However, with telecast events and mobile communication devices, such friendly wagers can be placed remotely; yet the ability to collect payment can be more difficult given the distance between participants.

Some betting platforms presently exist on the market to connect players together to facilitate wagering bets. However, these platforms are generally highly regimented and regulated, and often, due to the nature of potential gambling involved, require specific laws to be instituted, as well as taxes collected in some cases. In many jurisdictions, such wagering on a formal platform is illegal. Many of such platforms seem too involved for use for simple wagers between friends watching the game at home, or players who are physically at the same sporting event who wish to merely bet a few dollars between each other. Additionally, such platforms tend to take a cut of any payment in order to fund the platform and to make a profit. If there were a platform by which casual players could place wagers, for fun or using currency, in a friendly, peer-to-peer environment without the platform taking a cut from the proceeds, more people would wish to play, and events could be made more exciting for spectators.

Thus, there is a need for a new platform by which players can be connected, place wagers, and provide digital payment to one another without such a regimented atmosphere. Such a platform and system preferably allows players to name their own terms for each wager, including the amount, if any, wagered, the conditions of the wager, and the players involved. Additionally, in such a system, the players themselves are to determine who is the winning player, rather than the platform itself. As such, the players must instruct the platform on who won, which then, in turn, awards the winner.

Some inventions have been made that attempt to form such a wagering platform. For example, U.S. Pat. No. 9,697,680 applies to online peer to peer gaming, but unlike the present invention, does not establish an open source form for peers to create the terms of their own bets. The outcome of the bets is based on cooperative games of skill, rather than based on events that the user may or may not have any affect over. “Teams” as this patent describes them are defined as groups that bet competitively against one another, whereas Teams of the platform of the present invention are groups wherein bets may be placed. The competition is the opposing party or parties in the team, where a thread or series of bets may be placed by the entire group of users. Outcomes are determined by a transactional server which ensures winning players receive their winnings. Users of the present invention are responsible for determining the outcome of the bets, as many of the bets on the platform will be placed in person, and are therefore unverifiable by technology without a record of competition by users or witnesses.

Similarly, U.S. Pat. No. 8.414,387 discloses a system for a third-party server, gaming server and tournament style competition. This process is for mobile apps and competitive game developers to have a system within bets can be placed for from user to user on the games. This is unlike the scope of the present invention, as it is solely configured for use on video games.

US Patent Application Publication No. 2010/0056237 relates to a betting system, wherein the system is tied to a betting agency that receives, places or modifies terms of a bet. This too is unlike the scope of the present invention, as it does not provide players the means by which they can set their own terms, and is useful without such a betting agency.

U.S. patent application Ser. No. 13/933,384 shows “Systems, methods, means and computer program products for initiating, tracking, resolving, and reporting information pertaining to bets among two or more users over a communication network are disclosed. Certain systems, methods, means and computer program products may permit users to create and modify bet parameters, and may report bet parameters and results to other users.”

### SUMMARY OF THE PRESENT INVENTION

The present invention is a social media platform for sports fans and video gamers. The product, namely a mobile device application and web-based platform, employs a digital currency called a “DittoMarc™,” which users can purchase to wager with their friends within the site. Users can purchase Red DittoMarcs, which are “For Fun,” at 10 for $1 plus a service fee. When a user has accumulated enough DittoMarcs for various milestones, they are eligible for prizes. Prizes may range from DittoMarc swag like T-shirts to gift cards.

There is no “cash out” for Red DittoMarcs. Green DittoMarcs are purchased within the site for $1 each plus a service fee per transaction, where all purchased money will be held in an escrow account, and the service fee will be transferred to our bank account. Users may keep a green DittoMarc balance for as long as they choose, or may cash out at any time for an additional service fee.

While users have a balance of DittoMarcs in their profile, they are able to wager the DittoMarcs on anything with their friends. DittoMarc provides the platform to place the wagers, but does not create users' wagers, does not arbitrate the outcomes, and does not take any percentage of the bets.

A user could purchase a sum of DittoMarcs one time, and make multiple wagers with their friends before cashing out, and DittoMarcs will only be paid the fee on the initial purchase and the cash out, but not on any of the individual bets the user makes with the balance in the account.

Users are not required to maintain a balance in their account to have a profile on the platform of the present invention, or to build their network of friends on the platform. Users are required to have a balance equal to or greater than the amount of any wager they create in order to execute the wager with their friends. Red and Green DittoMares are the only currency users are able to wager on the platform of the present invention, and are prohibited from using any other form of currency. It should be noted that DittoMarcs are may be a crypto currency, and may carry value outside of the platform of the present invention in some alternate embodiments of the present invention.

DittoPool Description: DittoPool is an umbrella feature on the platform of the present invention which is configured for various “pooled” or “pot” categories of wagering, which could result in a winner take all, or combination of 1st, 2nd, 3rd place etc. Pools can be divided evenly, by dollar amount, or by a predetermined percentage established by the members of any particular pool, or by the Captain/Commissioner of the pool.

DittoPool is distinct from regular One-on-One or Team bets on the platform, as these bets will be placed in a common Many-to-Many pool system. The bet resolution system of the present invention is twofold: in the outcome of the bets, users are required to identify themselves as “Winner” or “Non-Winner,” prompting the appearance of the rating system which requires the user to rate the other party or parties interacting on that bet. If there is a conflict, users are notified that failure to resolve the conflict timely will negatively impact their user rating and ability to place future bets on the platform of the present invention.

Whereas YouBetMe allowed users to bet anything, like dinner, or tickets to an event, users of the platform of the present invention may only bet with DittoMarcs, which are purchased within the platform, and not otherwise acquired. Because of that system, users were left to resolve bets on their own, but users of the present invention are prompted to complete the bet after the first party involved declares the bet to be complete.

The embodiments described above are exemplary and are not to be taken as limiting in any way. They are merely illustrative of the principles of the disclosure. Various changes, modifications and alternatives will be apparent to one skilled in the art. Accordingly, it is intended that the art disclosed shall be limited only to the extent required by the appended claims and the rules and principles of applicable law.

### BRIEF DESCRIPTION OF THE DRAWINGS

The novel features believed characteristic of the disclosed subject matter may be set forth in any claims that are filed later. The disclosed subject matter itself, however, as well as a preferred mode of use, further objectives, and advantages thereof, may best be understood by reference to the following detailed description of an illustrative embodiment when read in conjunction with the accompanying drawings, wherein:

FIG. 1 illustrates a process flow chart for the DittoMarc™ process of the present disclosure;

FIG. 2 shows a second flowchart illustrating novel aspects of the present disclosure;

FIG. 3 is a block diagram illustrating portable multifunction devices with touch-sensitive displays in accordance with some embodiments;

FIG. 4 illustrates a portable multifunction device having a touch screen in accordance with some embodiments;

FIG. 5 illustrates a profile template for use by a participant in the DittoMarc™ platform;

FIG. 6 shows an account page for a user of the DittoMarc™ platform;

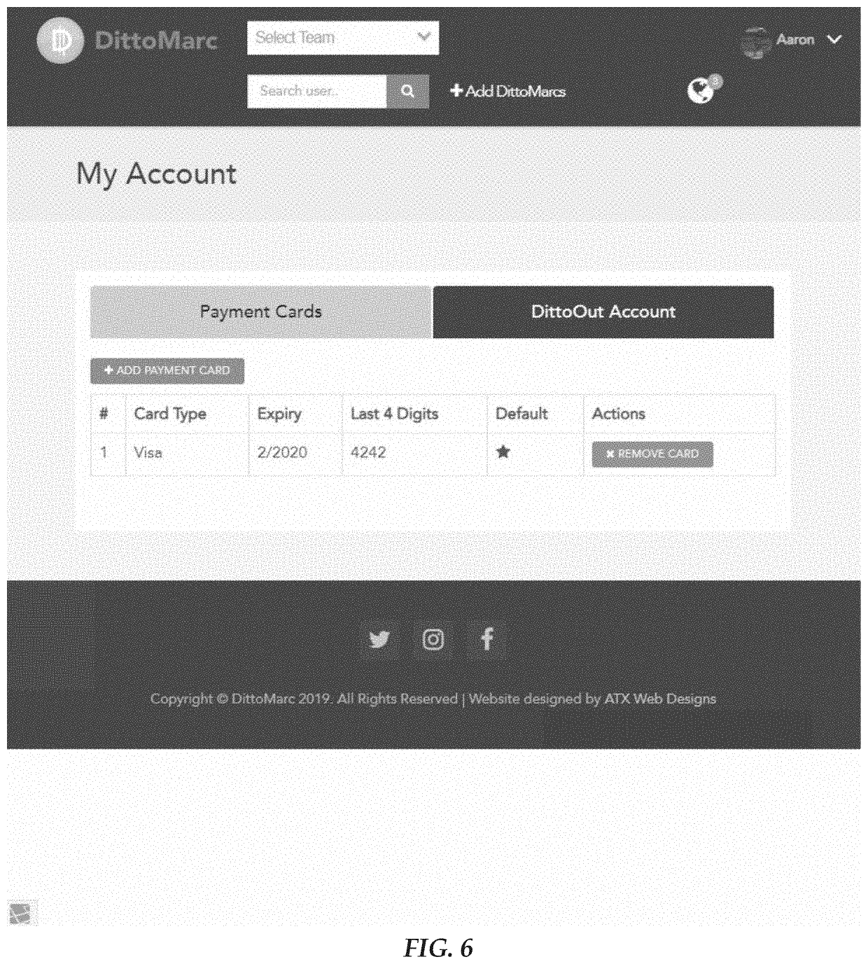

FIG. 7 illustrates a template for providing credit card information to charge for participation in the DittoMarc™ platform;

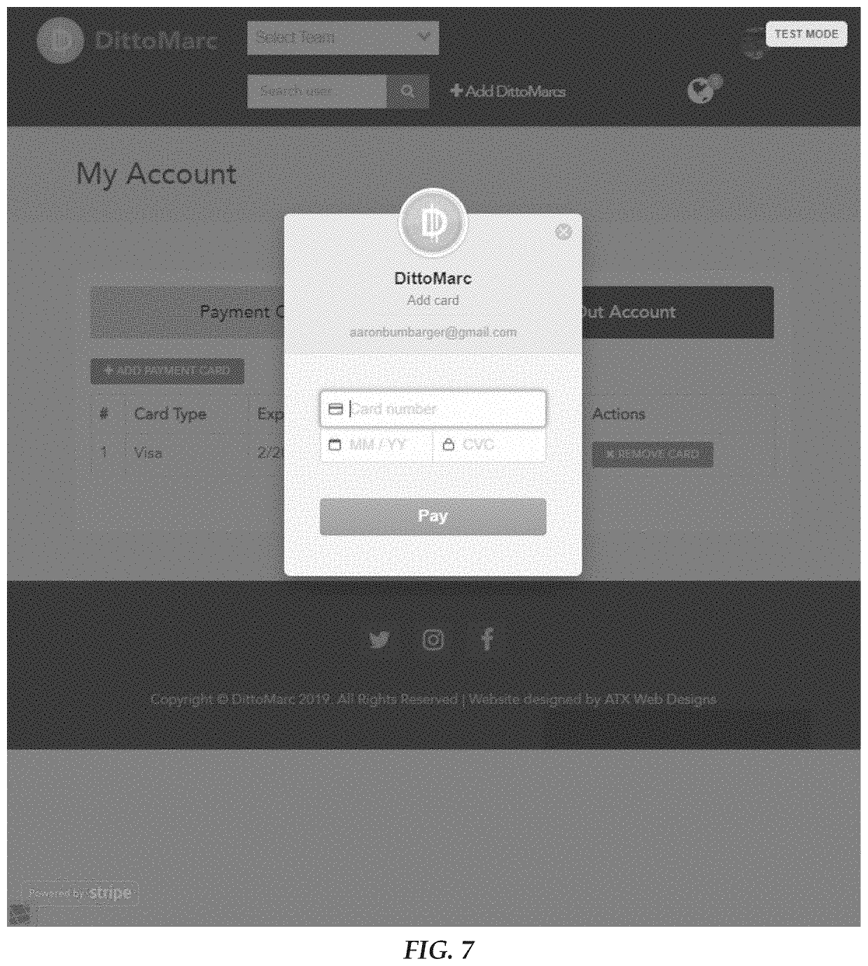

FIG. 8 illustrates a dashboard through which a participant may select a specific intention in playing on the DittoMarc™ platform;

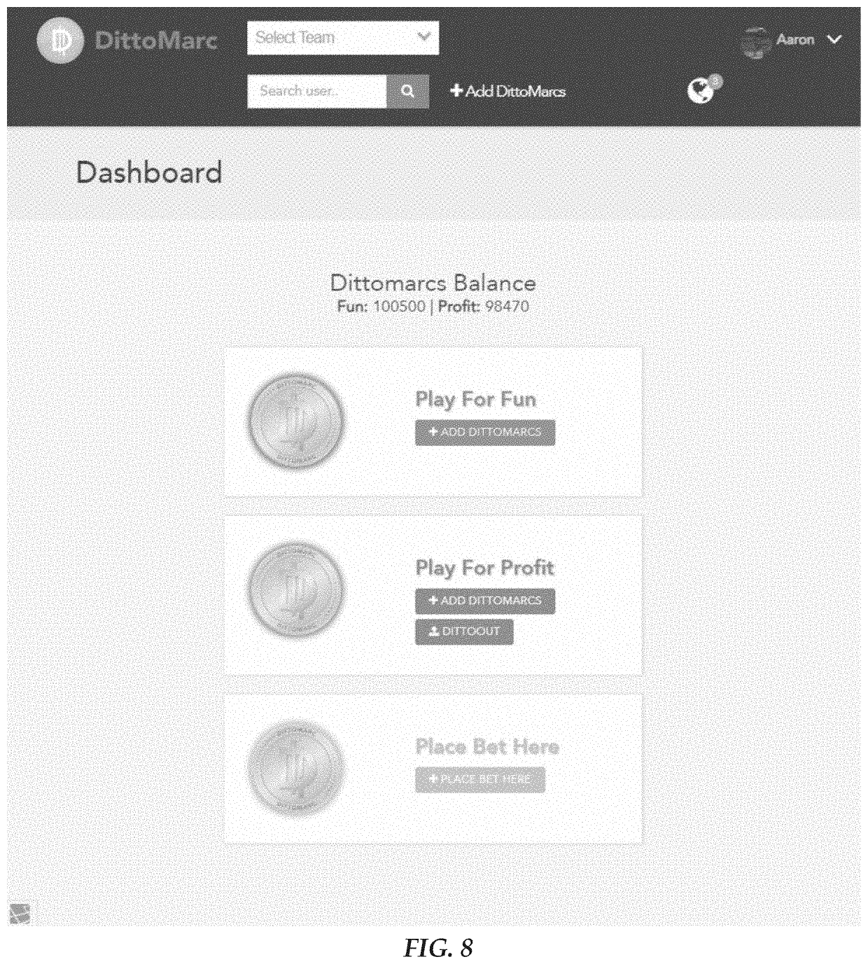

FIG. 9 illustrates a template for charging participants using the DittoMarc™ platform to permit play on the platform;

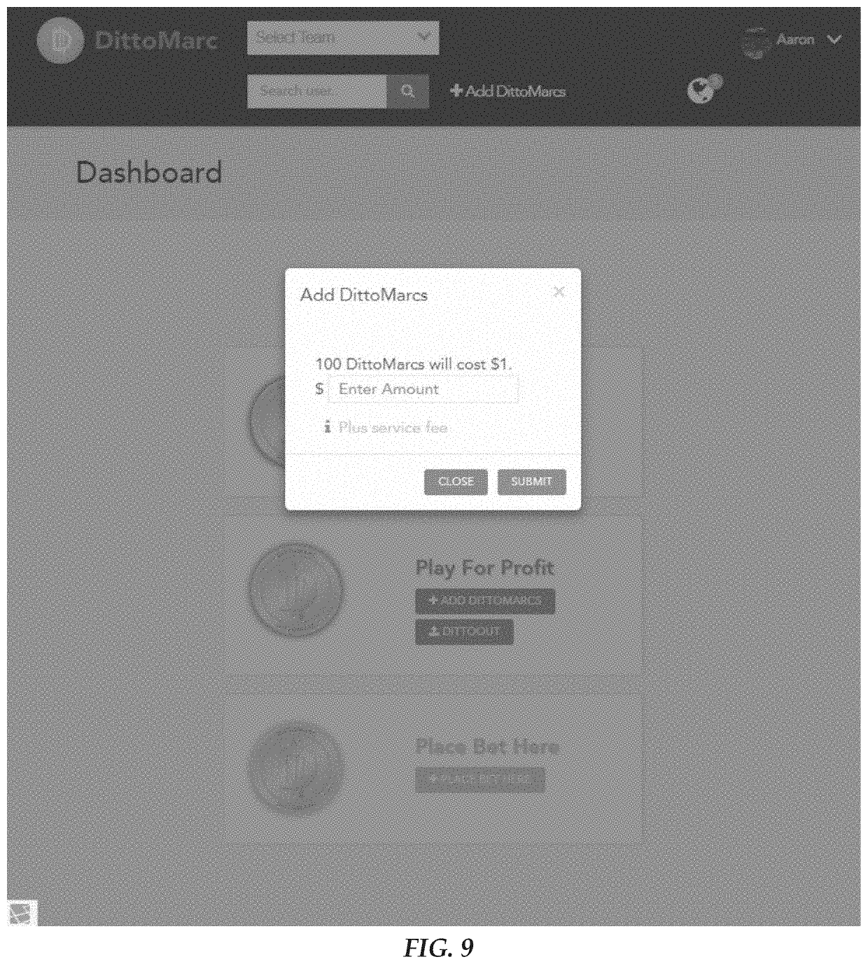

FIG. 10 illustrates a platform for adding to DittoMarc™ currency to the platform of the present disclosure;

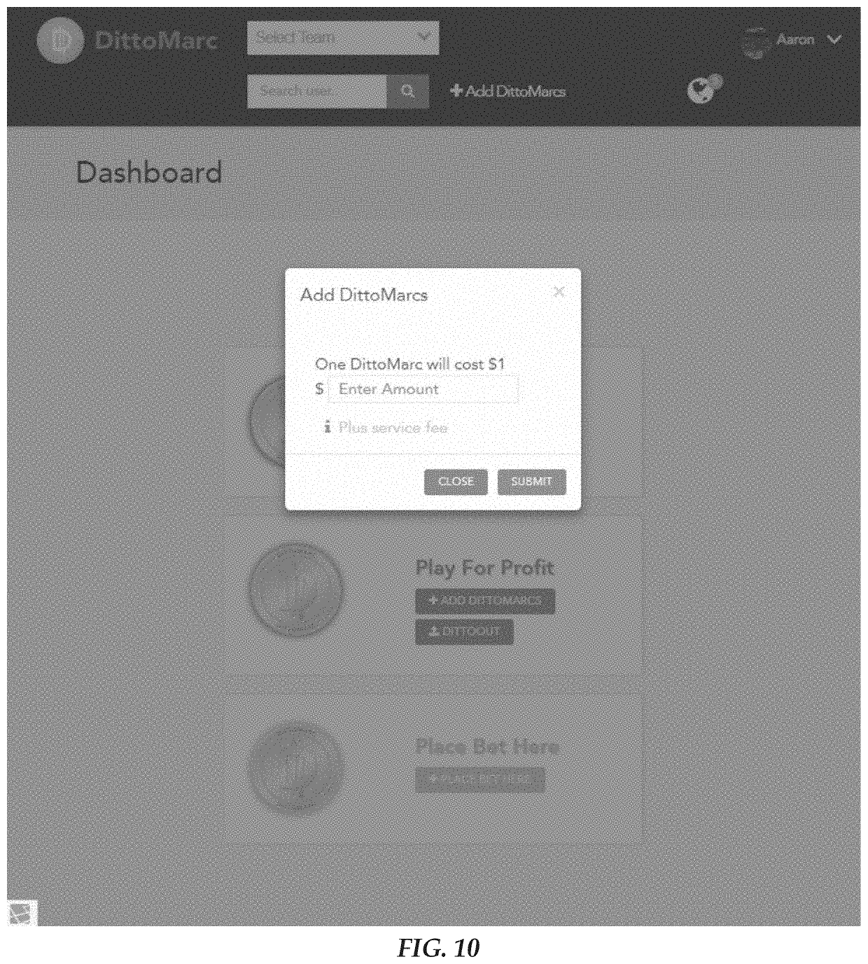

FIG. 11 shows further a user interface for facilitating payment into the DittoMarc™ platform;

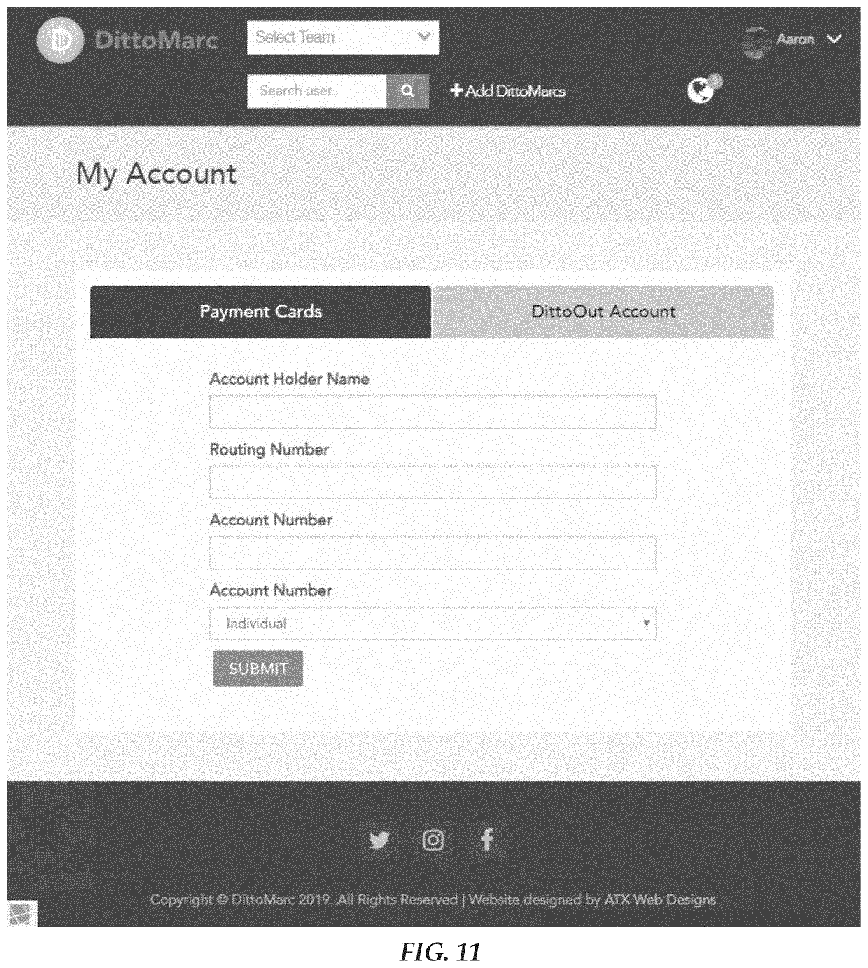

FIG. 12 depicts a plurality of teams that may participate or use the system collectively or independently;

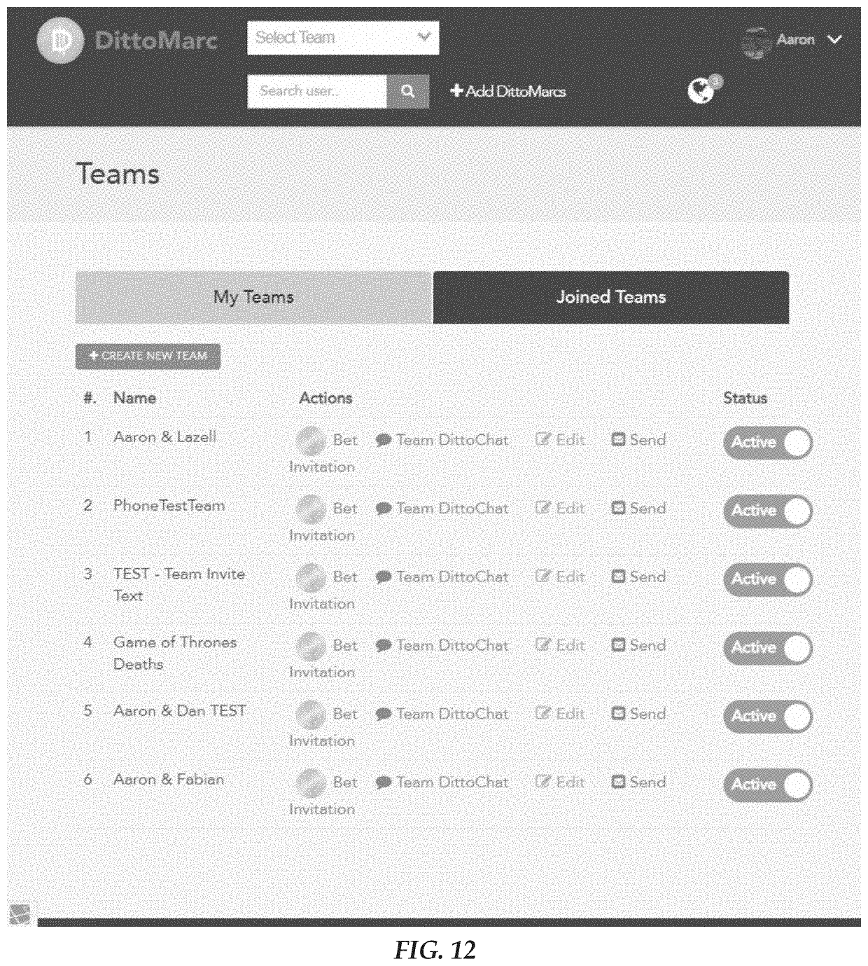

FIG. 13 illustrates a template for adding a new team to the list of DittoMarc™ teams;

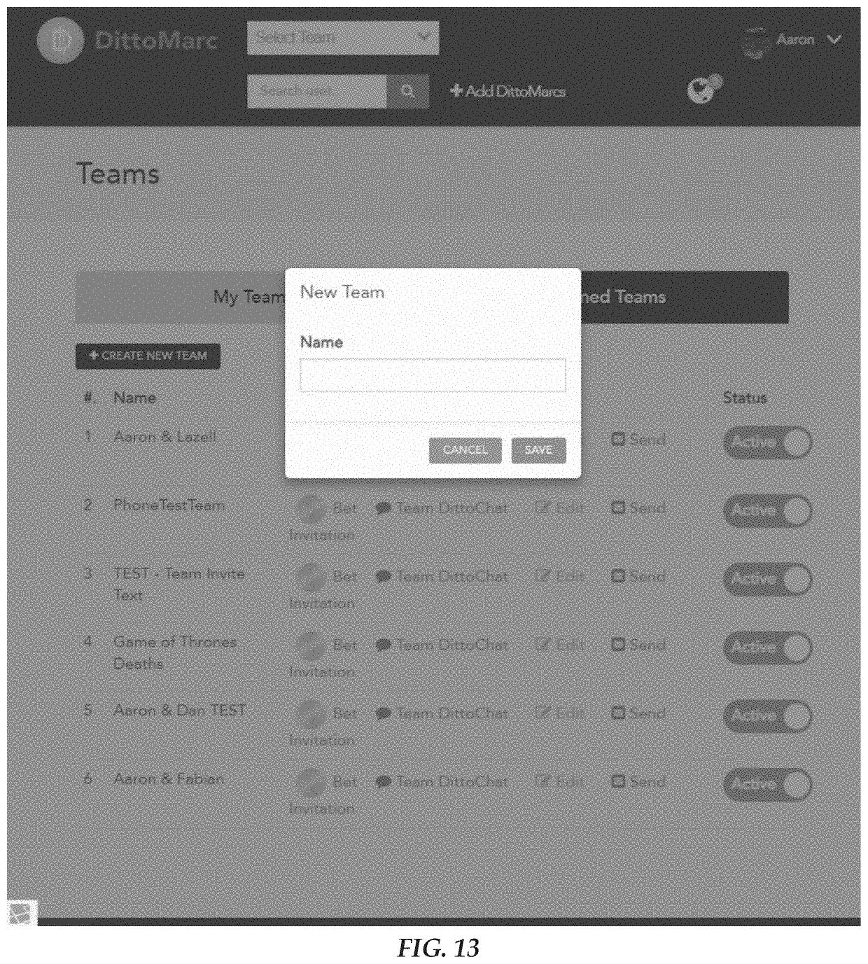

FIG. 14 depicts a template for sanding by way of email and invitation to join the DittoMarc™ platform;

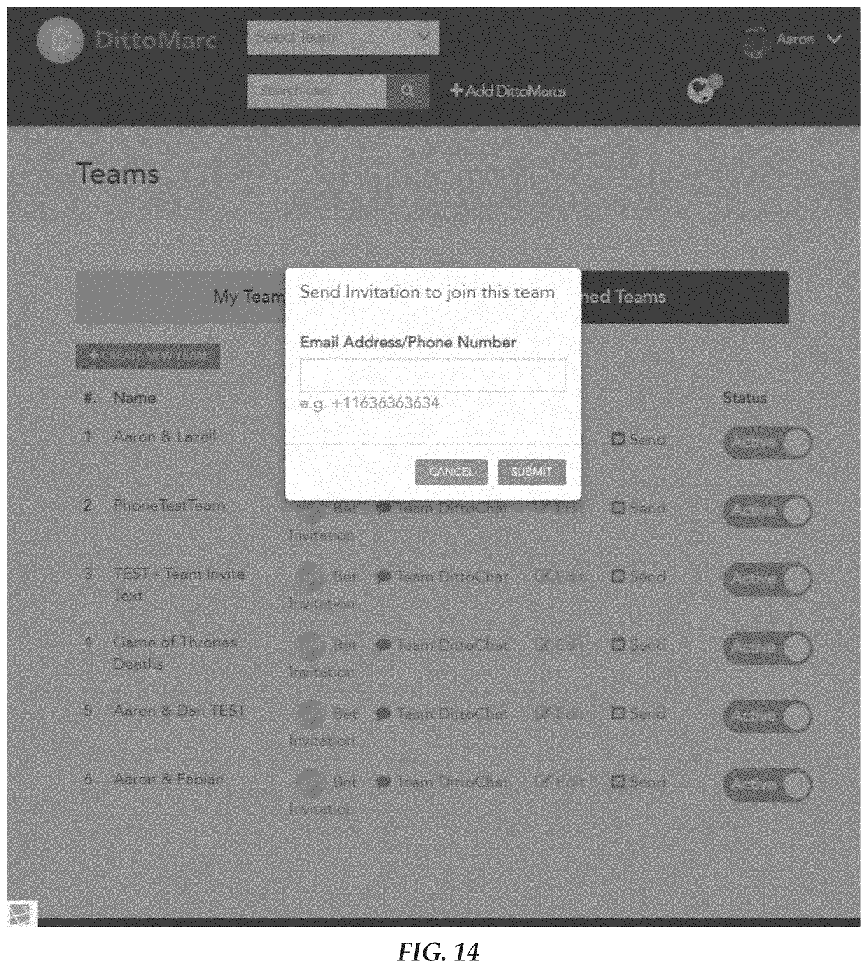

FIG. 15 provides a template whereby a user can provide descriptive information relating to a particular DittoMarc™ team using the platform of the present disclosure;

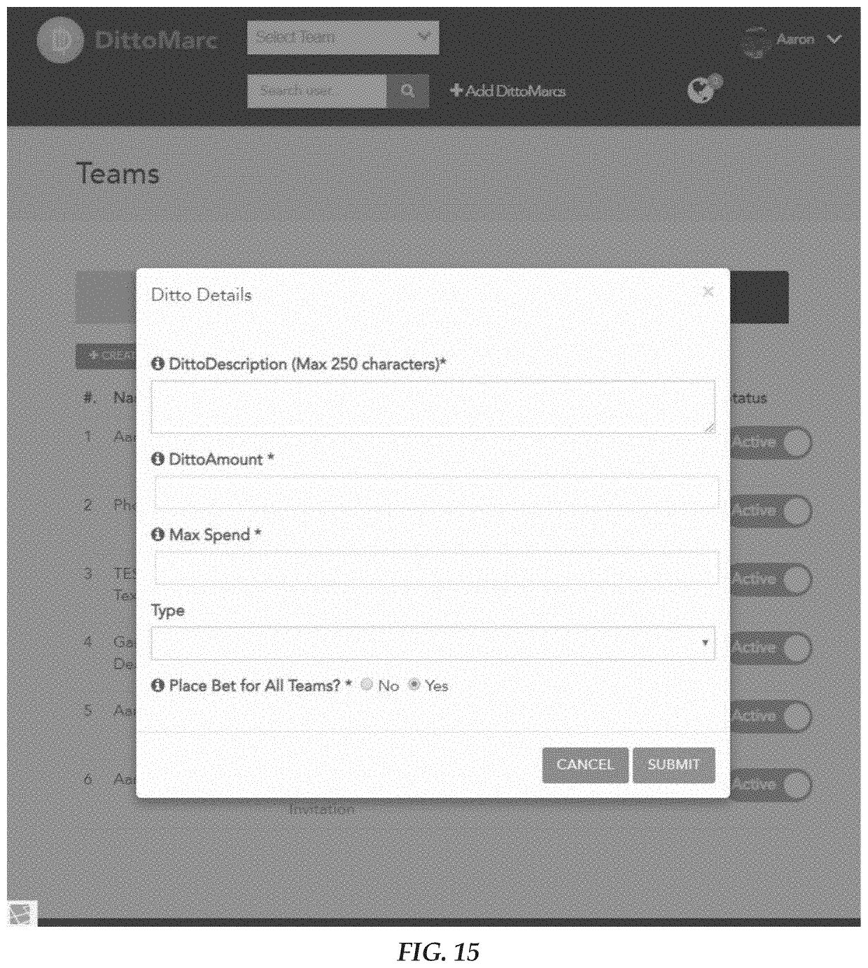

FIG. 16 depicts a chat mechanism by which users may communicate with one another and participating on the DittoMarc™ platform;

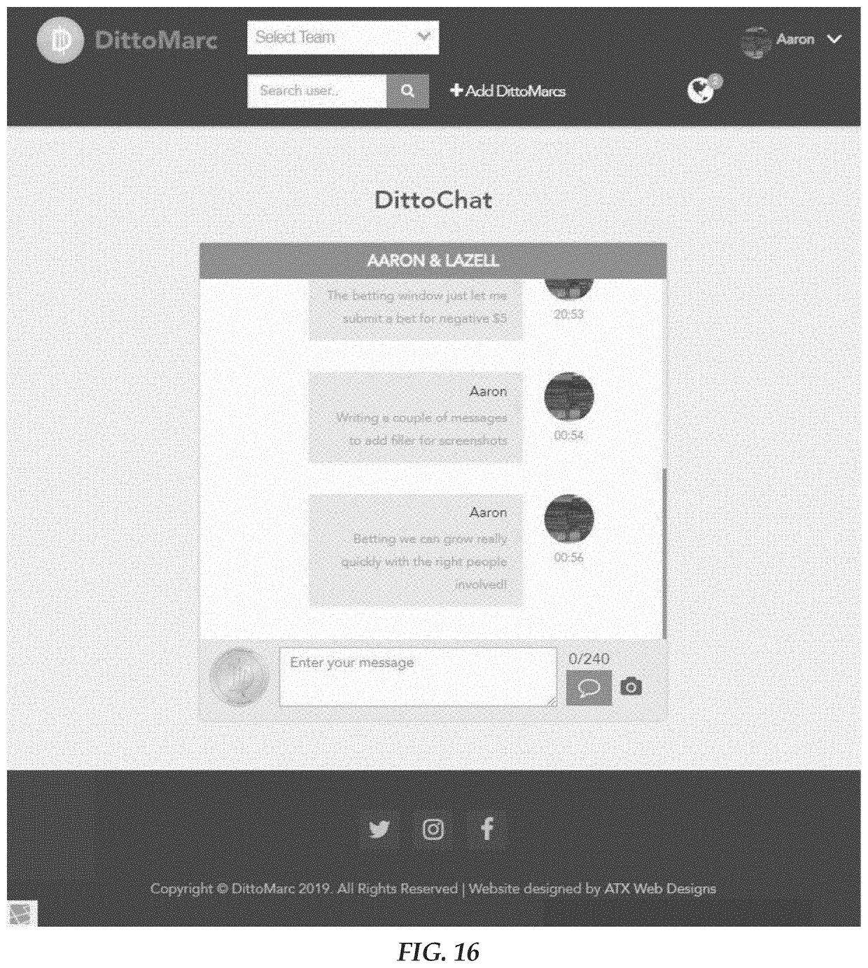

FIG. 17 illustrates the communication from the DittoMarc™ platform to a user to permit play at different levels;

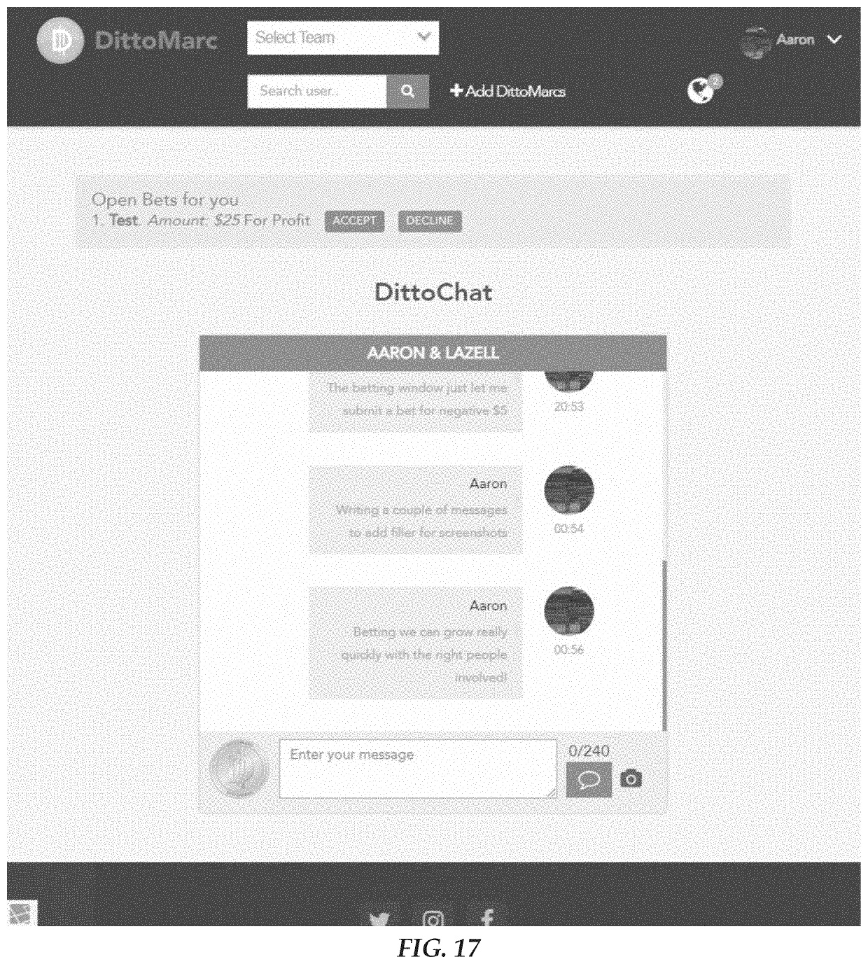

FIG. 18 illustrates the screen listing that provide invitations by watch a DittoMarc™ player may except or decline an invitation to use DittoMarc™ platform;

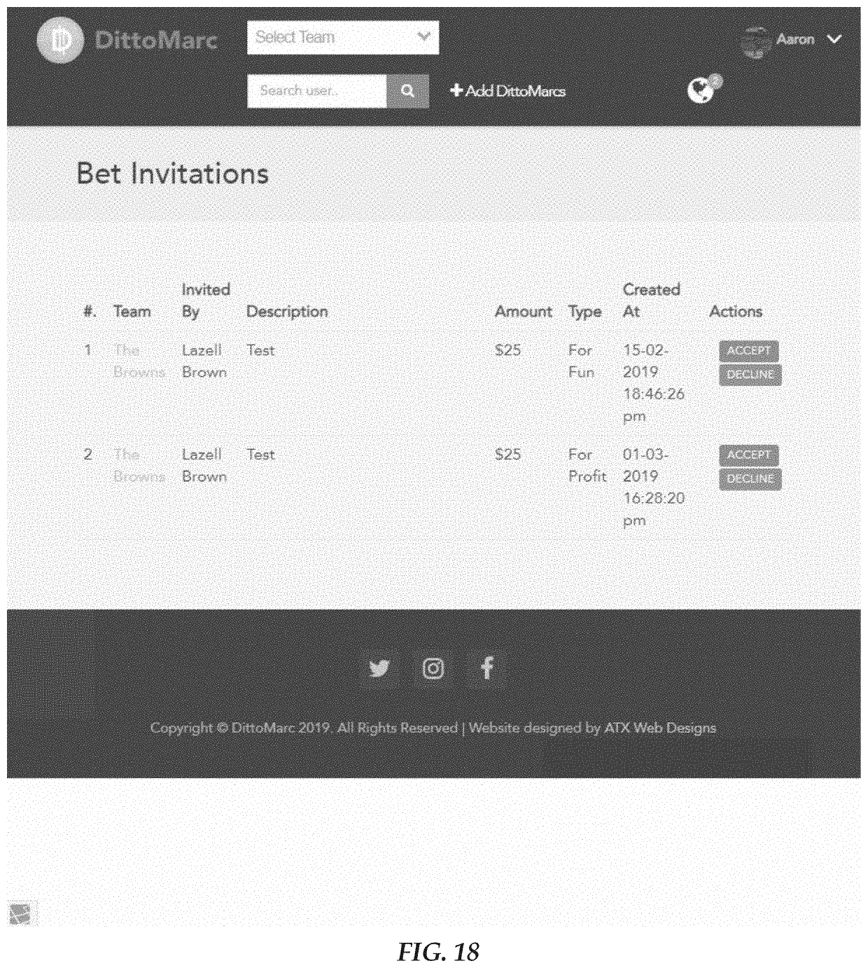

FIG. 19 shows a sub-template for communication to the user or to the participant for confirming acceptance of a particular bet using the presently disclosed platform;

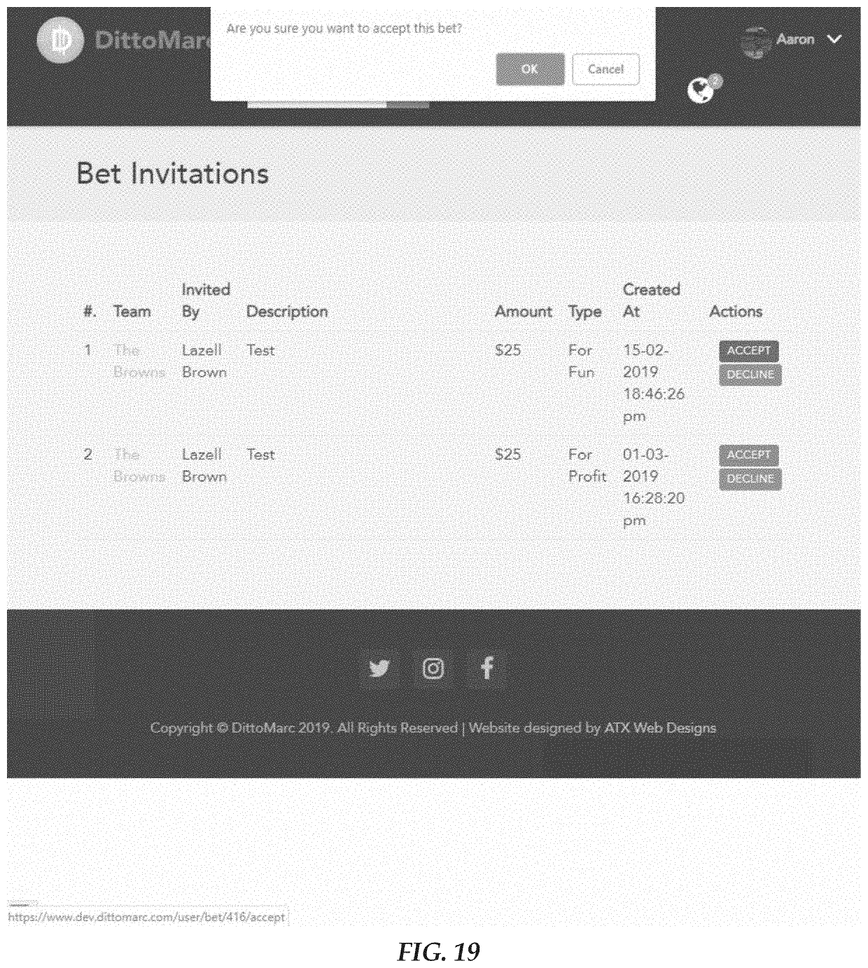

FIG. 20 shows a sub-template for communication to the user for verifying that the participant seeks to decline a particular bet;

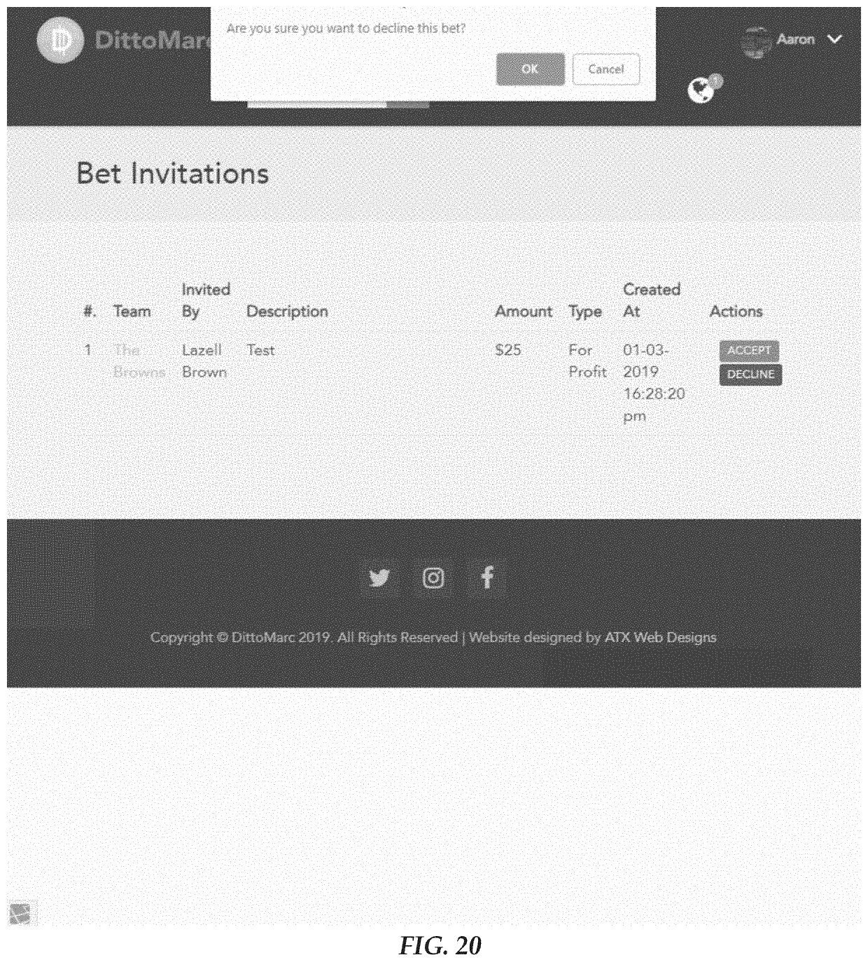

FIG. 21 shows a user interface for communicating to a participant user and reporting open bets, live bets, and completed bets;

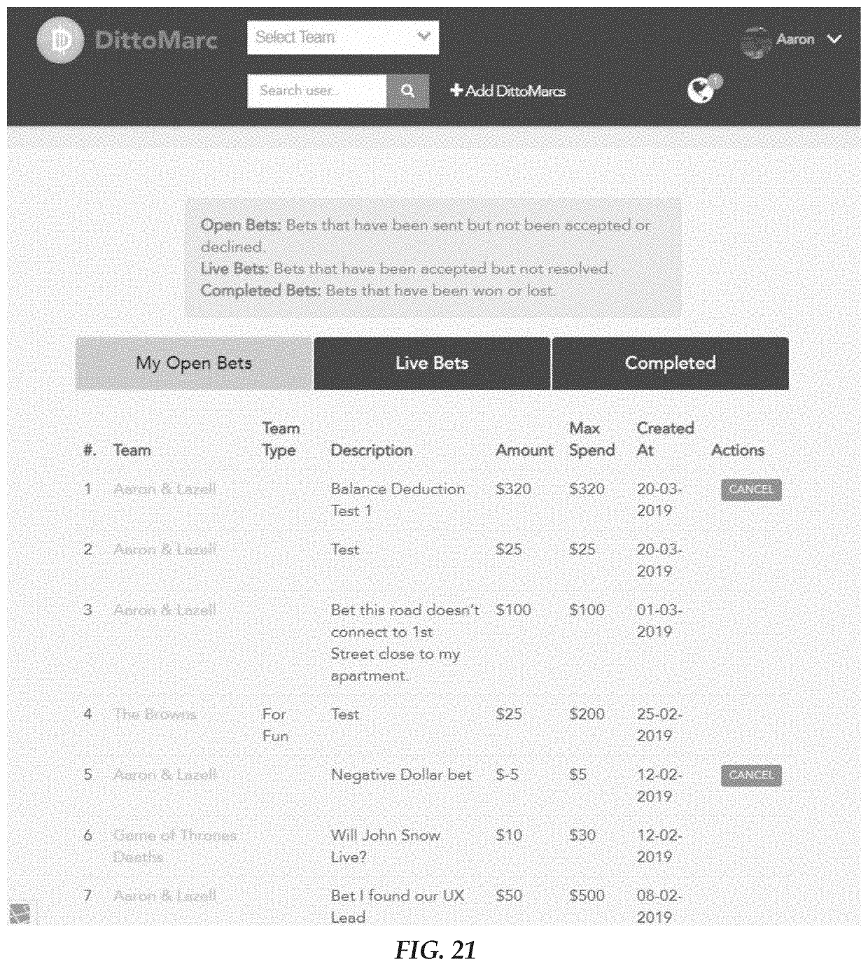

FIG. 22 shows actions that permit a user to cancel a particular bet made through the presently disclosed DittoMarc™ platform;

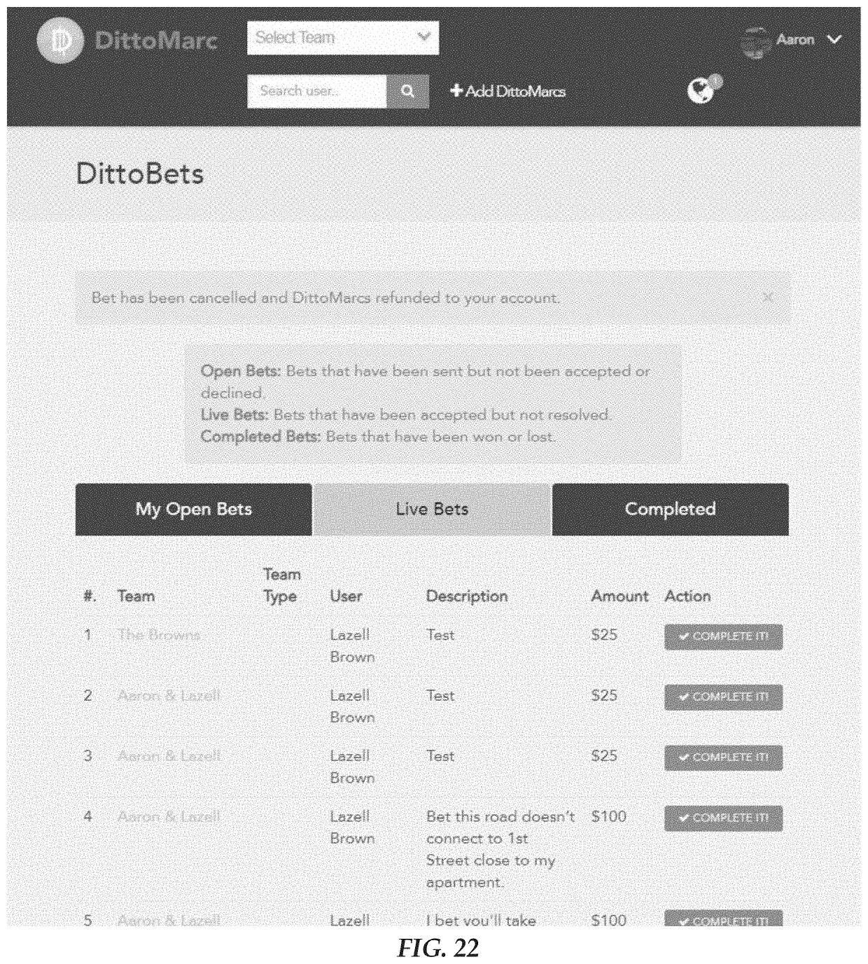

FIG. 23 shows a final results page indicating the results that a particular team or set of teams have accomplished using the presently disclosed system;

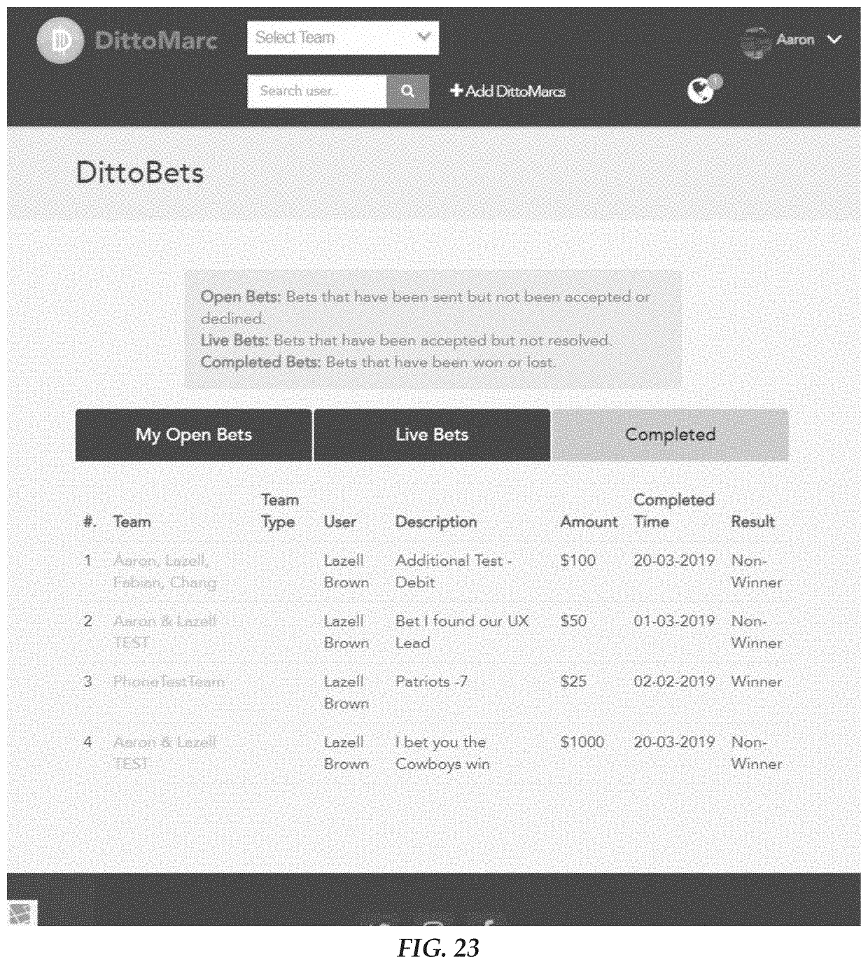

FIG. 24 illustrates a screen whereby the presently disclosed system supports the performance of a variety of conversations with DittoMarc™ platform users and participants;

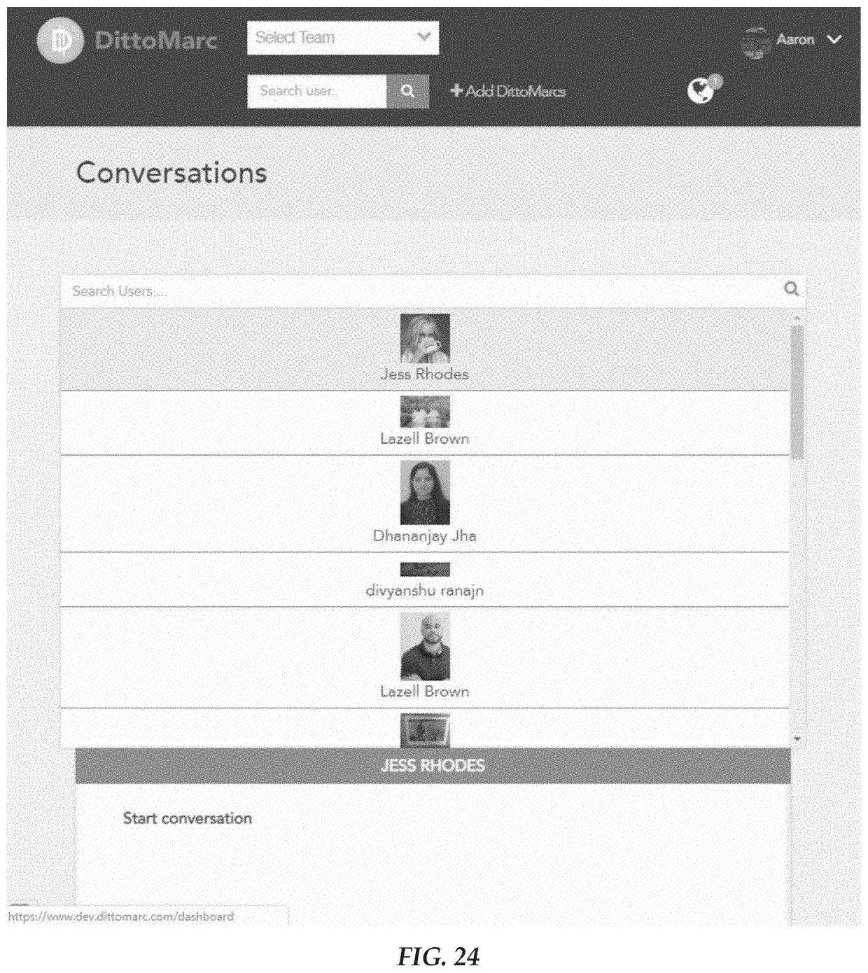

FIG. 25 illustrates the DittoMarc™ platform dashboard and the ability to select different teams at the DittoMarc™ platform;

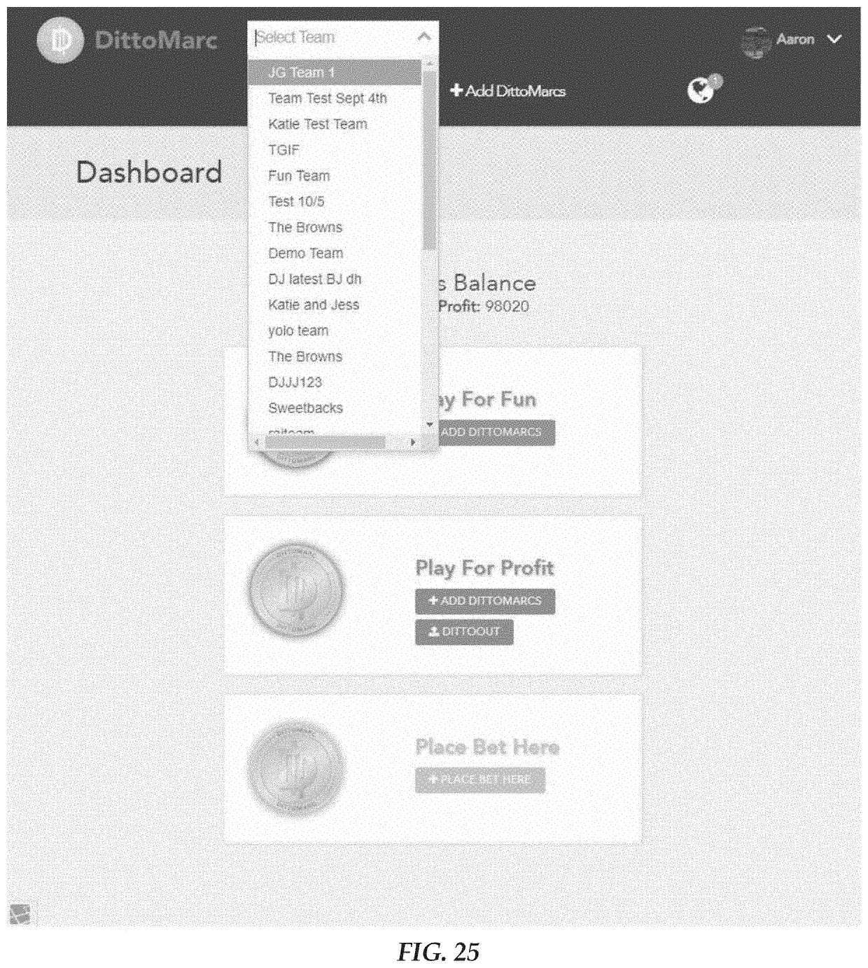

FIG. 26 provides a demonstration of an aspect of the present disclosure by which disputed bets may be addressed and resolved;

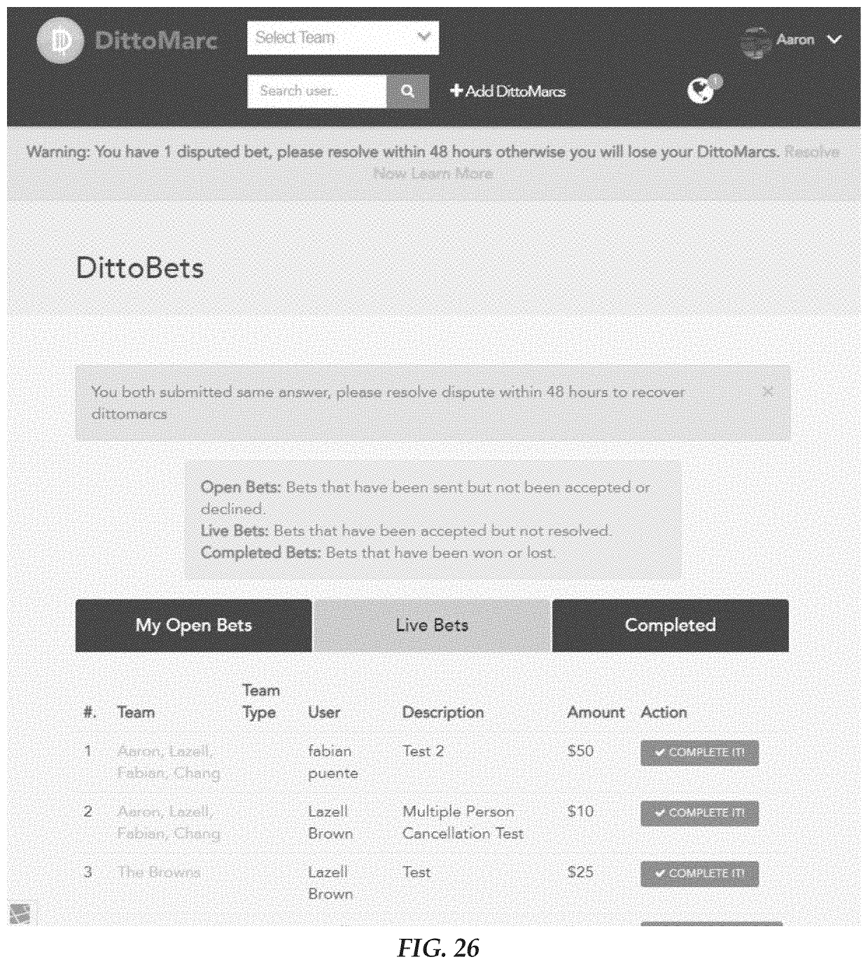

FIG. 27 depicts a completed dispute resolution and indicates communication to the user of the result of dispute;

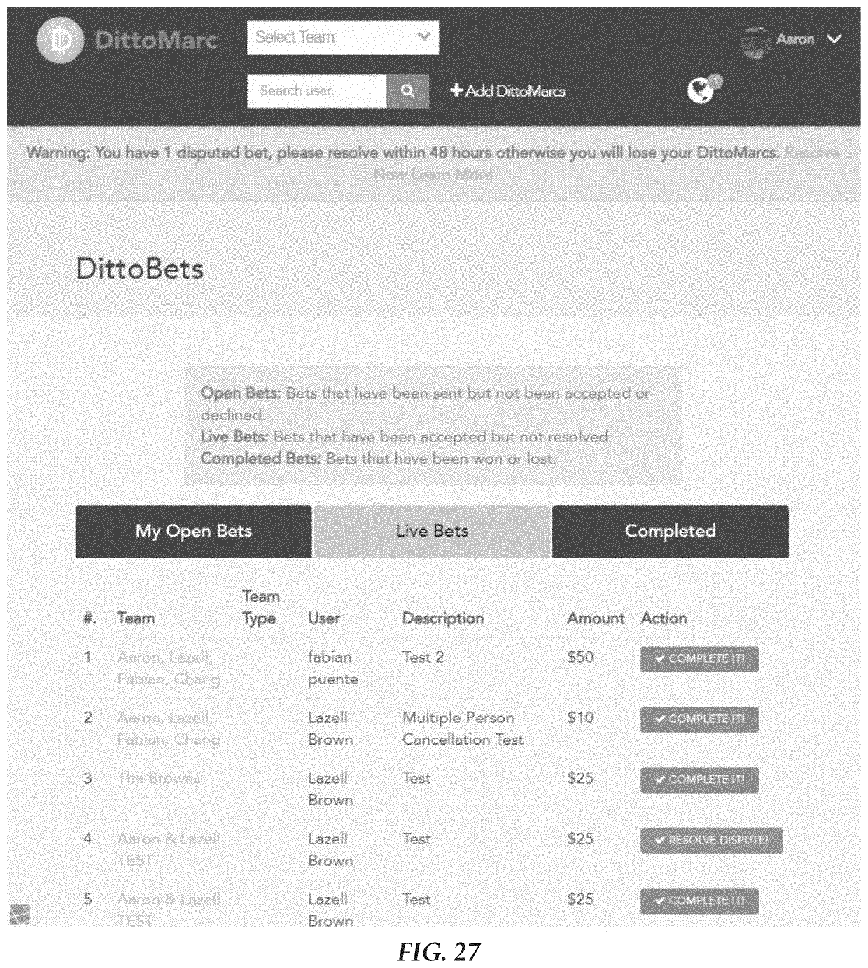

FIG. 28 reports the completion of about using the system of the present disclosure and identification of a participant as a winner or non-winner;

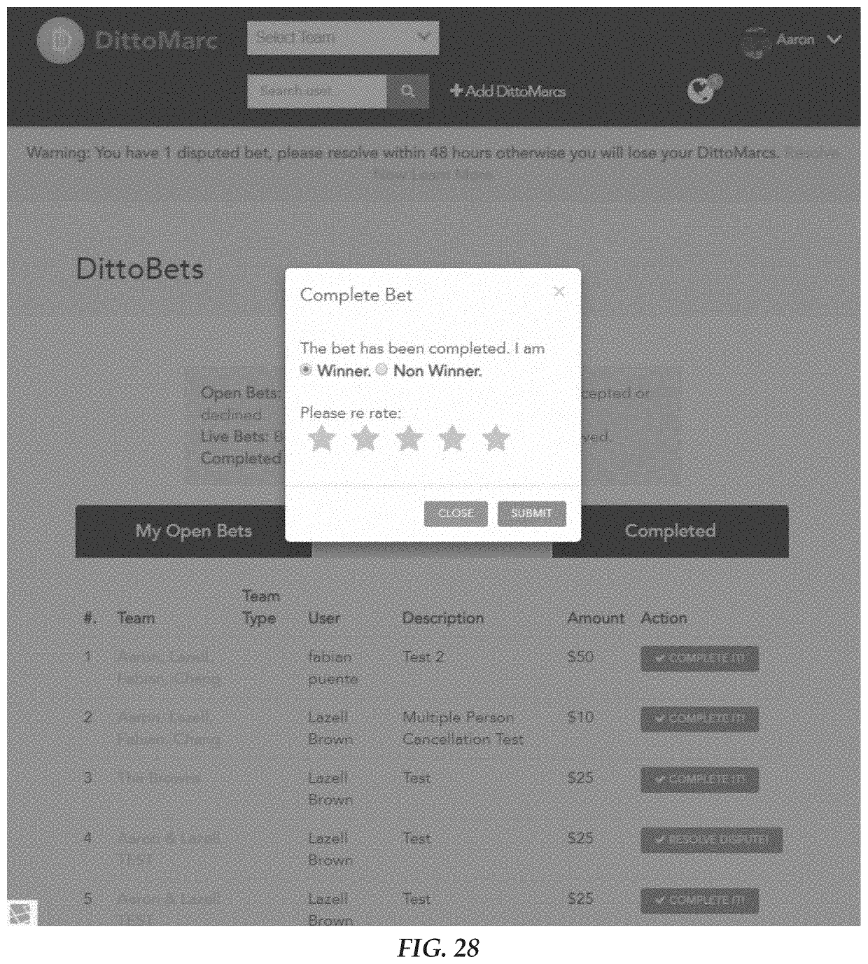

FIG. 29 illustrates a user interface for the completion of all system bets;

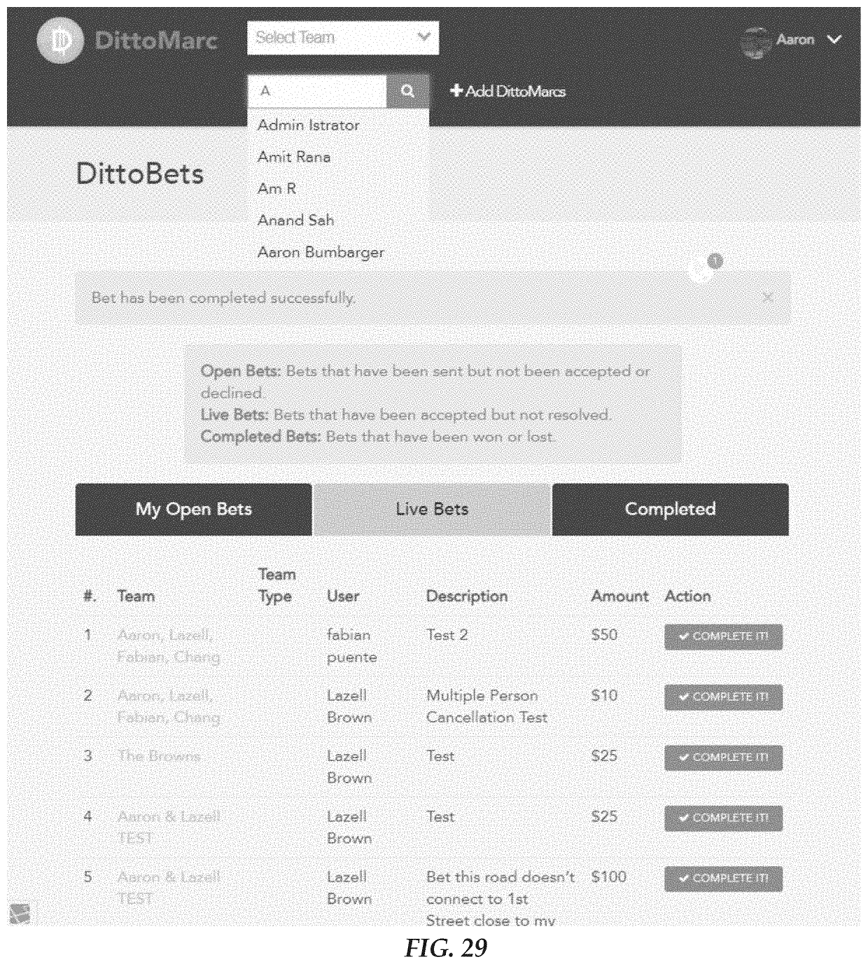

FIG. 30 shows the members of the DittoMarc™ platform and provides a way by which a user may send an invitation or initiate a DittoChat with a user in using the presently disclosed DittoMarc™ platform;

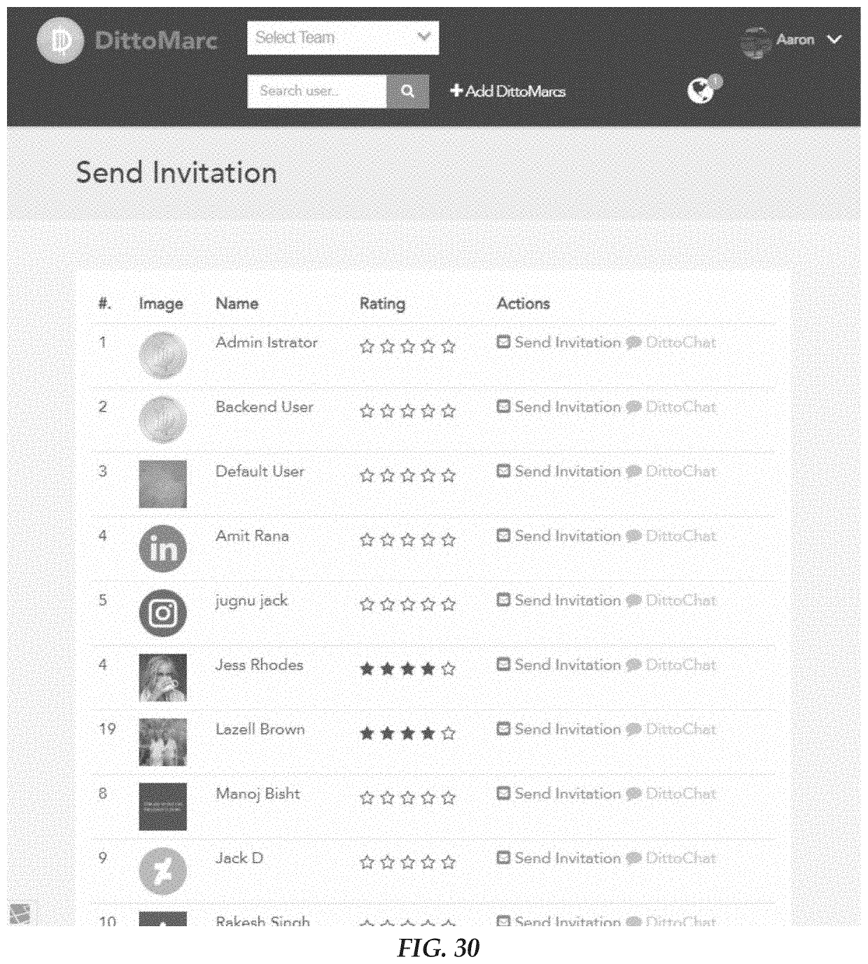

FIG. 31 shows the selection screen by which a user may access the DittoMarc™ platform;

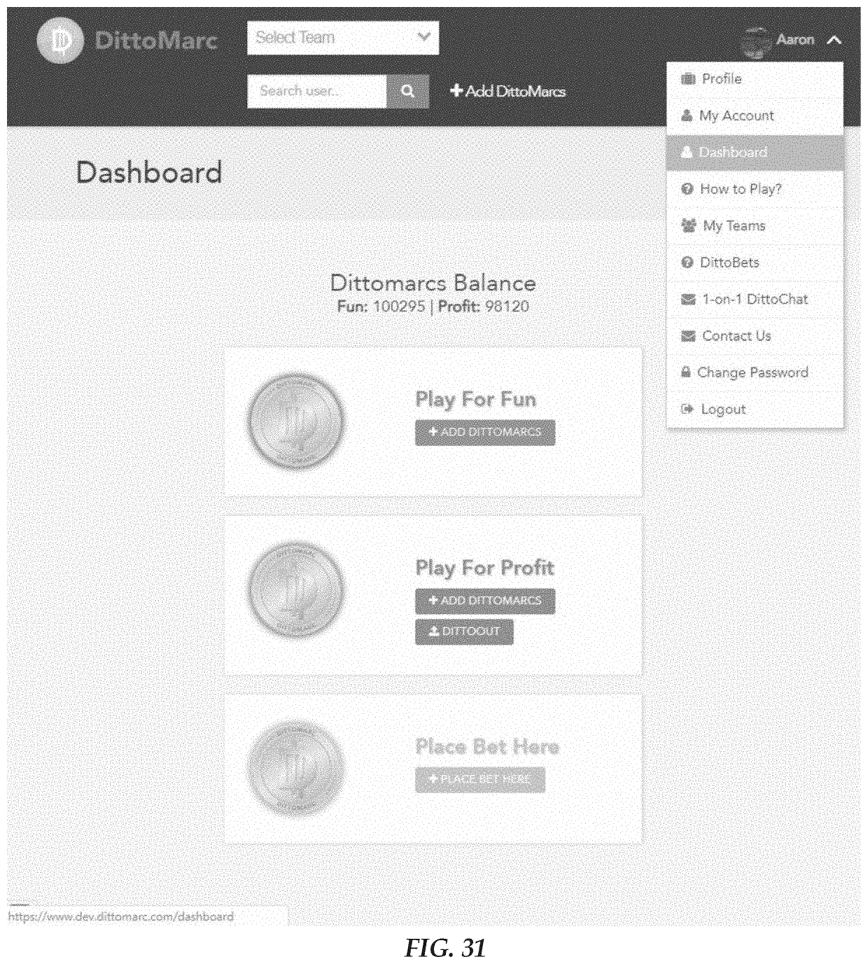

FIG. 32 illustrates a library of instructional resources for operating the presently disclosed DittoMarc™ platform;

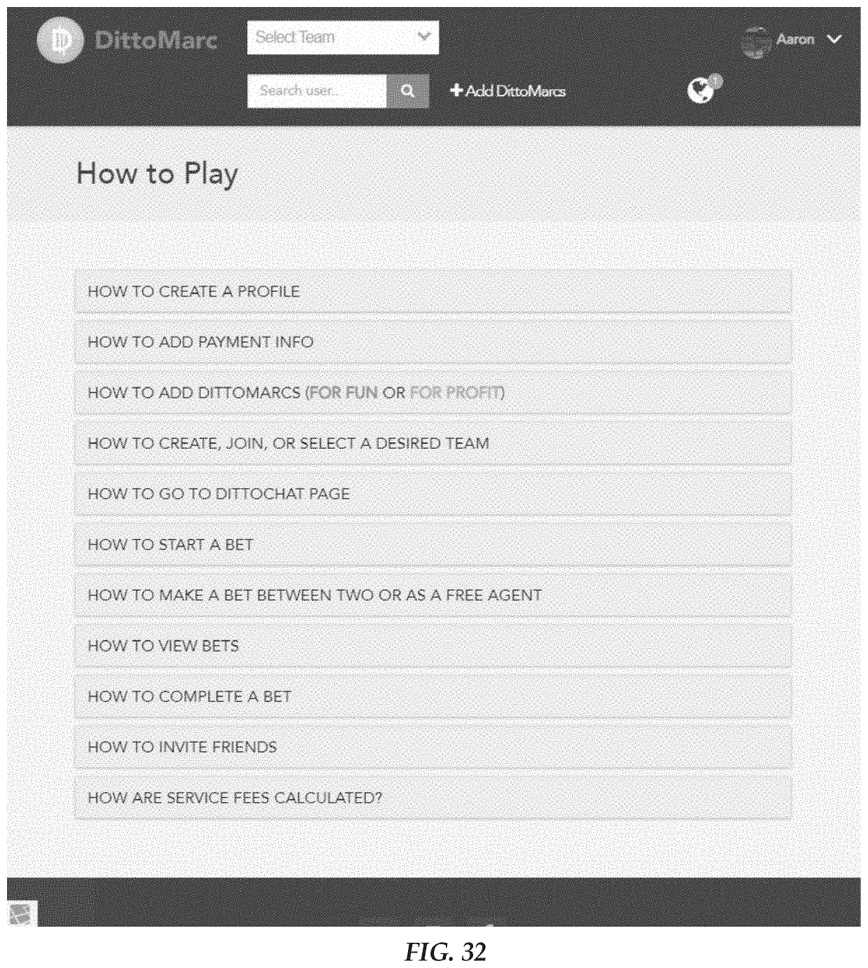

FIG. 33 illustrates an exemplary tutorial that the presently disclose platform provides to the participants;

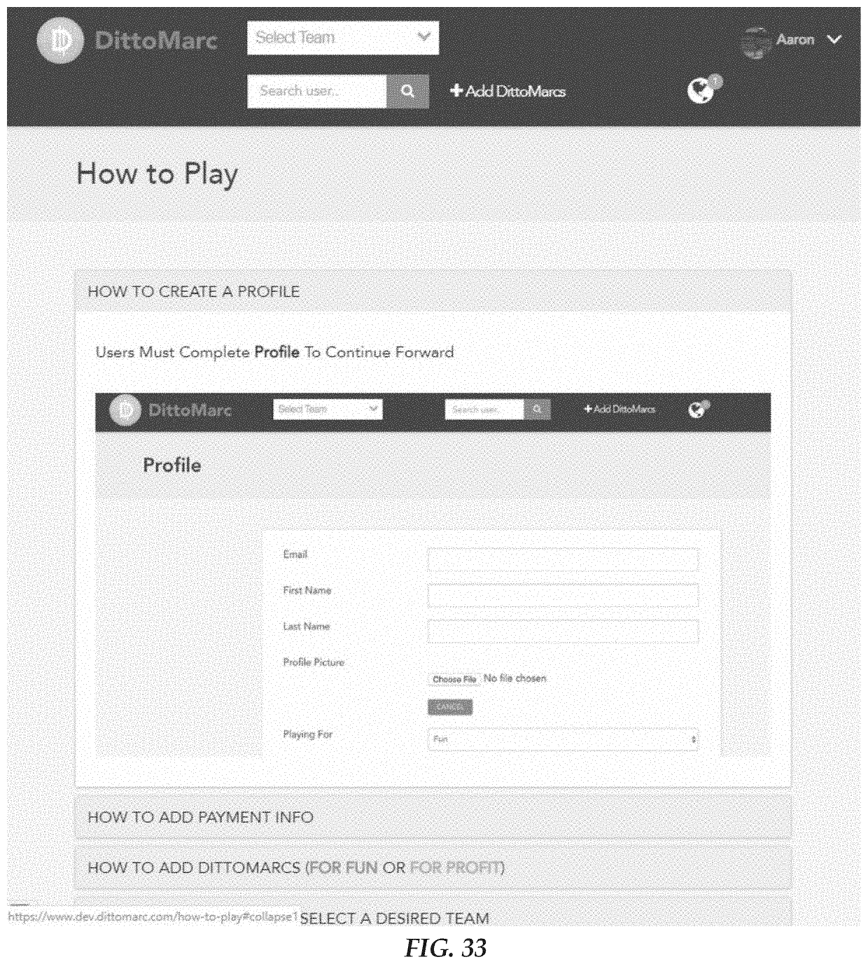

FIG. 34 illustrates a second tutorial for providing instructions in adding funds to the platform of the present disclosure;

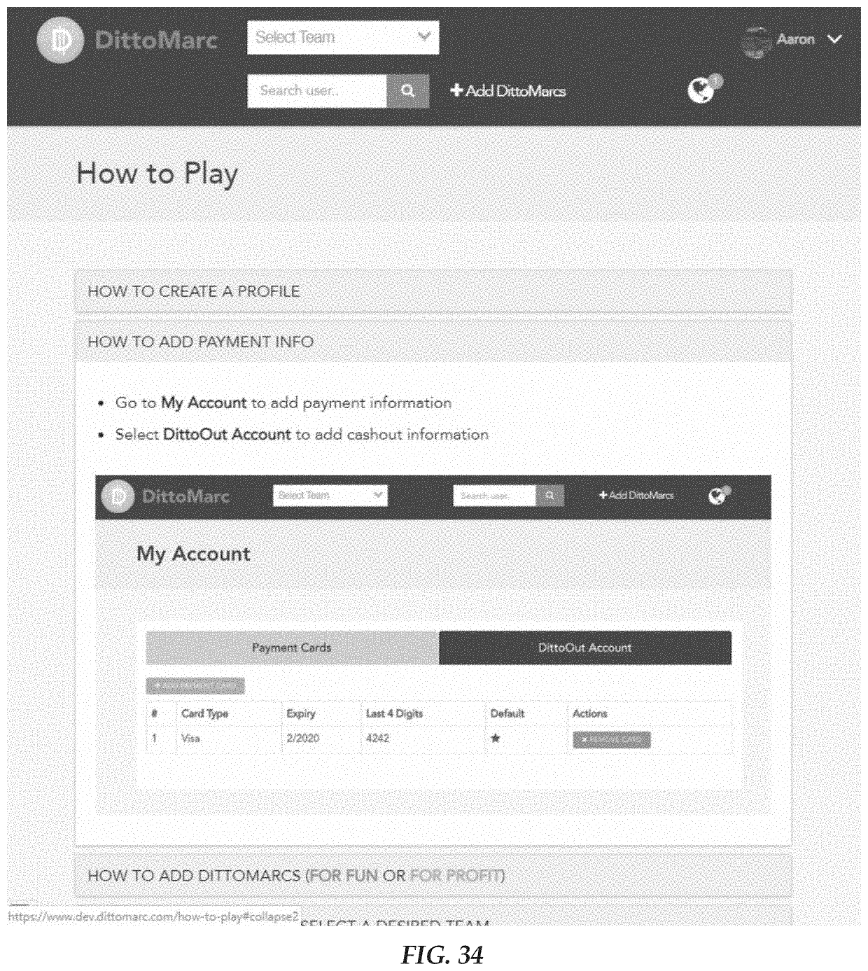

FIG. 35 illustrates the tutorial for teaching the user how to add DittoMarcs™ to the platform of the present disclosure;

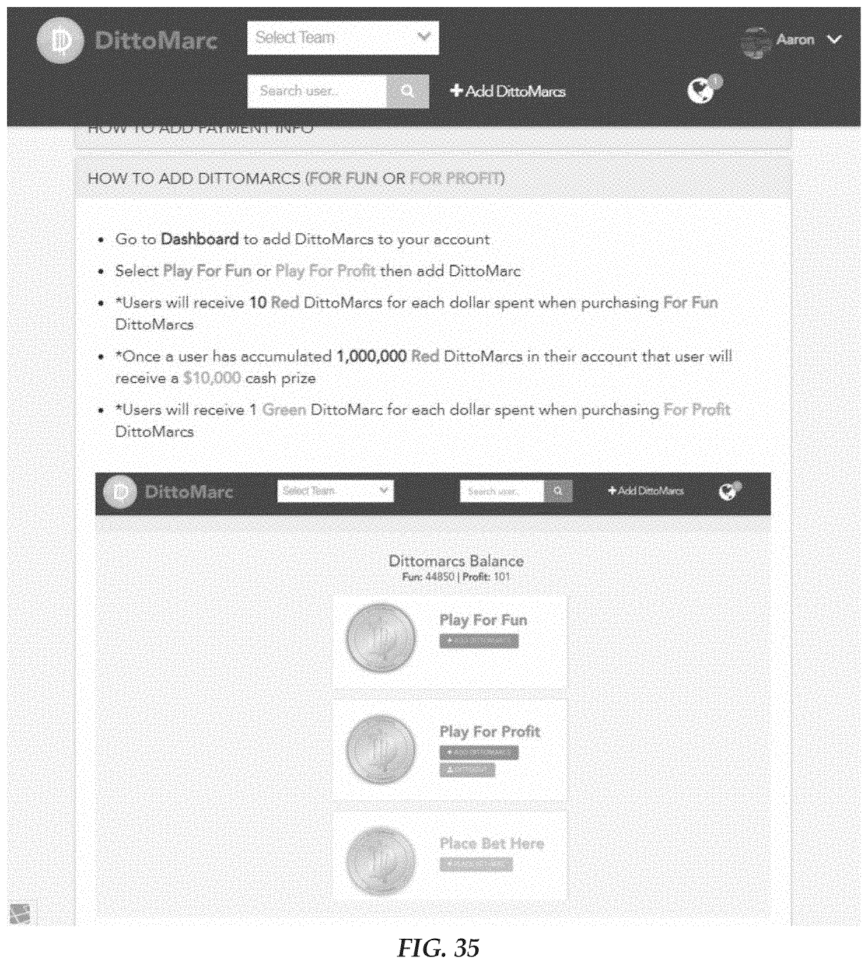

FIG. 36 illustrates the tutorial for teaching a user how to create, join or select a desired team for operating the DittoMarc™ platform;

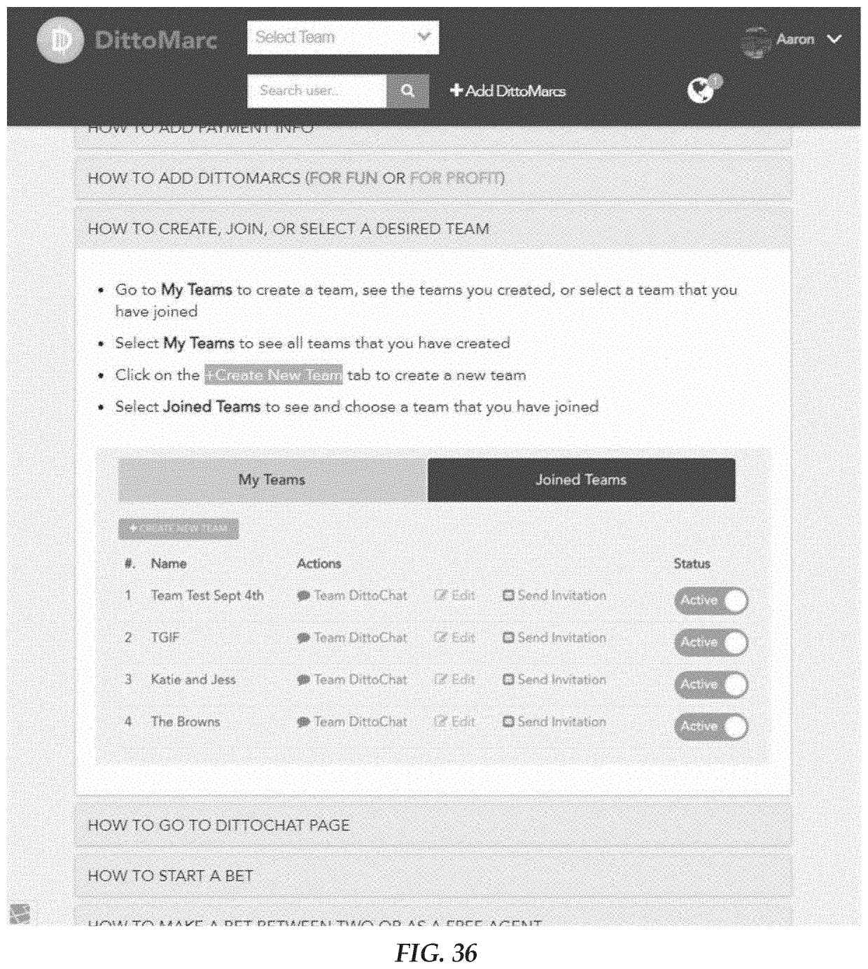

FIG. 37 illustrates a tutorial for educating the participant in how to go to a DittoChat page;

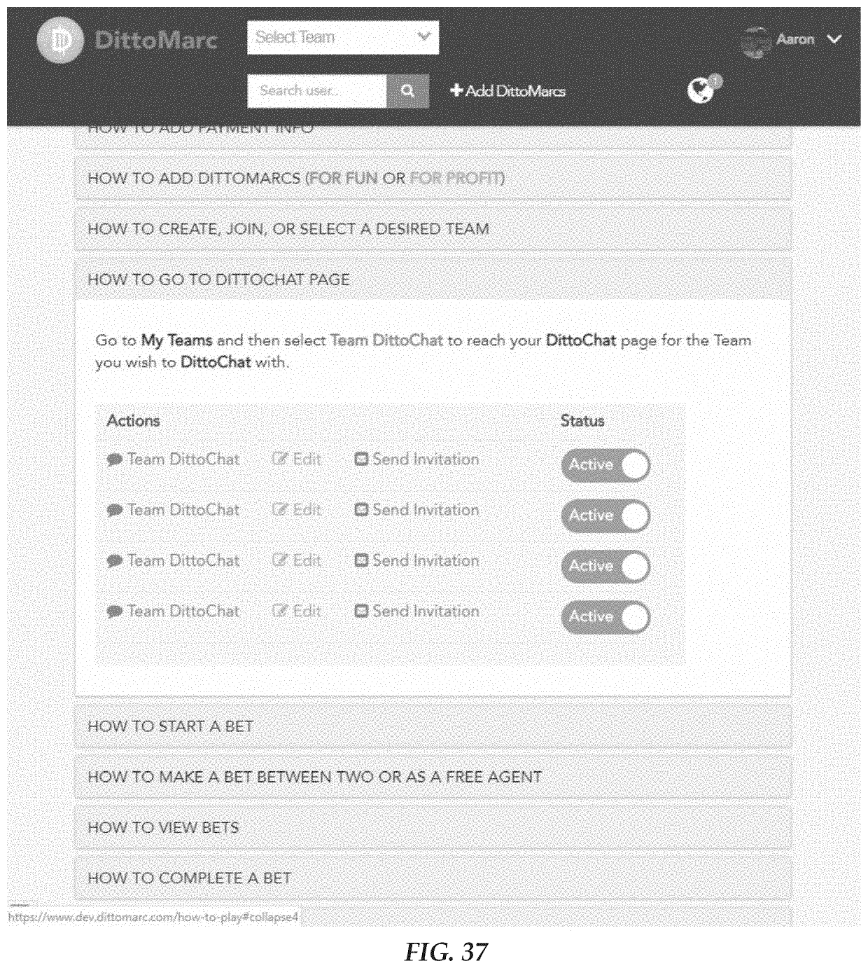

FIG. 38 illustrates the presentation of the tutorial for teaching a participant how to start a bet in the presently disclosed DittoMarc™ platform;

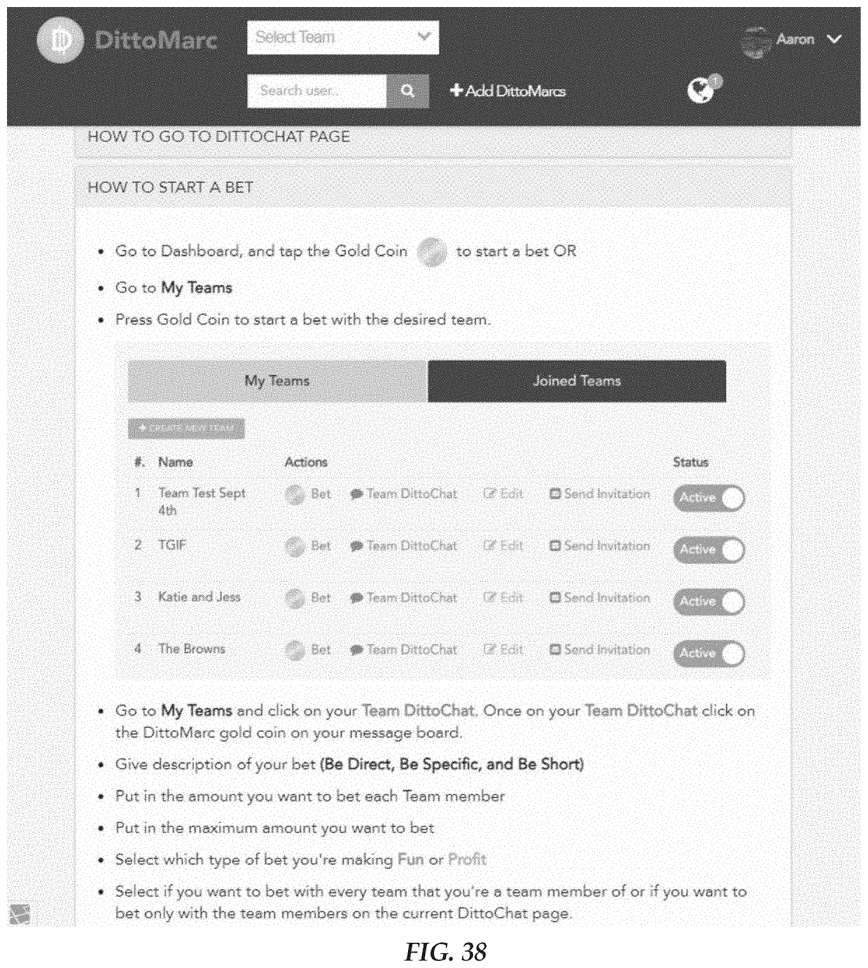

FIG. 39 provides a view of the DittoMarc™ dashboard for instructing, via a tutorial, how to select a particular team in operation of the present platform;

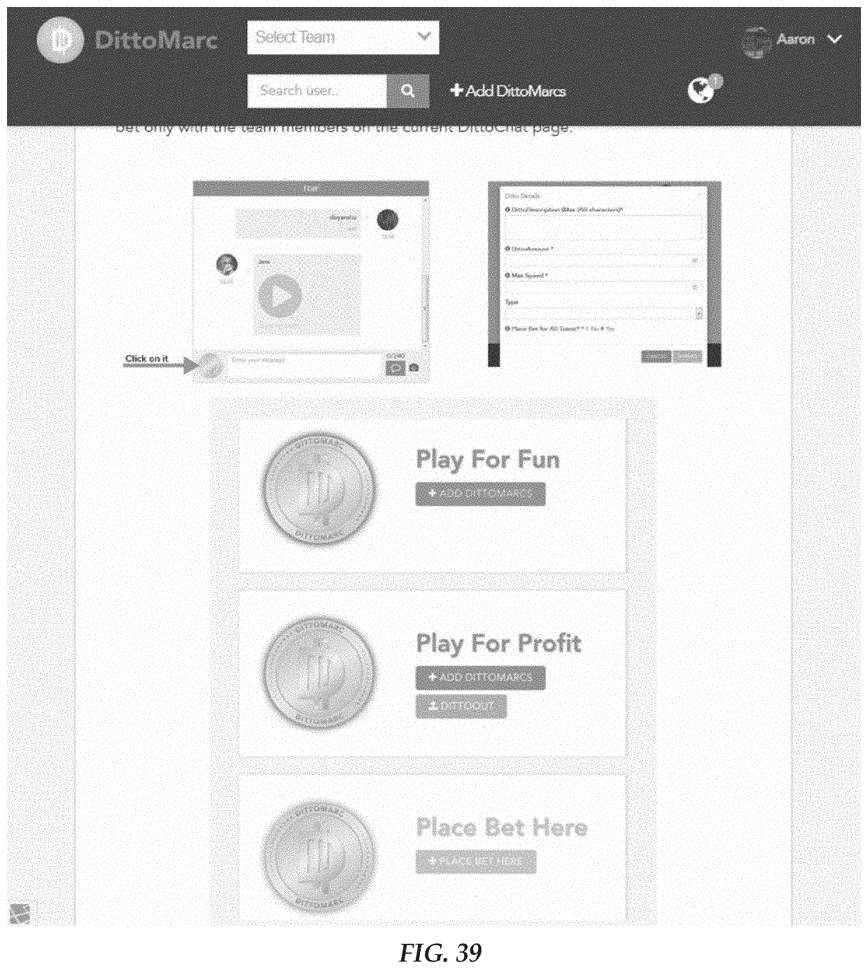

FIG. 40 illustrates a tutorial for teaching a user how to make a bet between two or three participants;

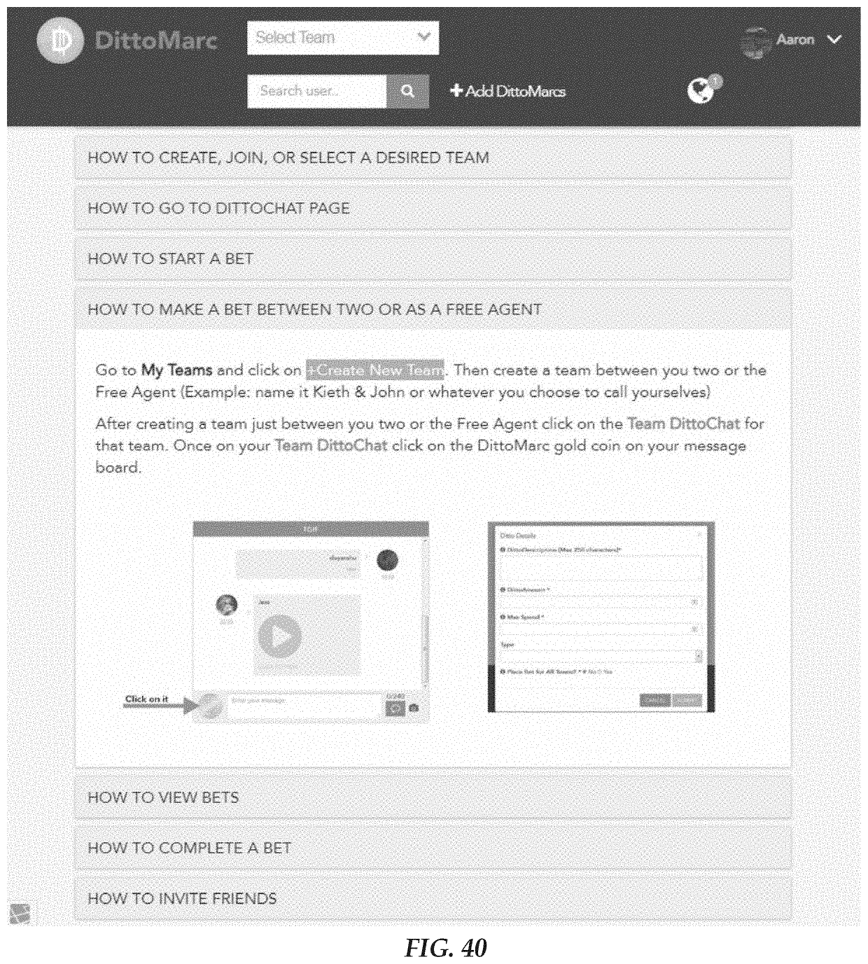

FIG. 41 shows how the presently disclosed platform illustrates a user in how to review bets;

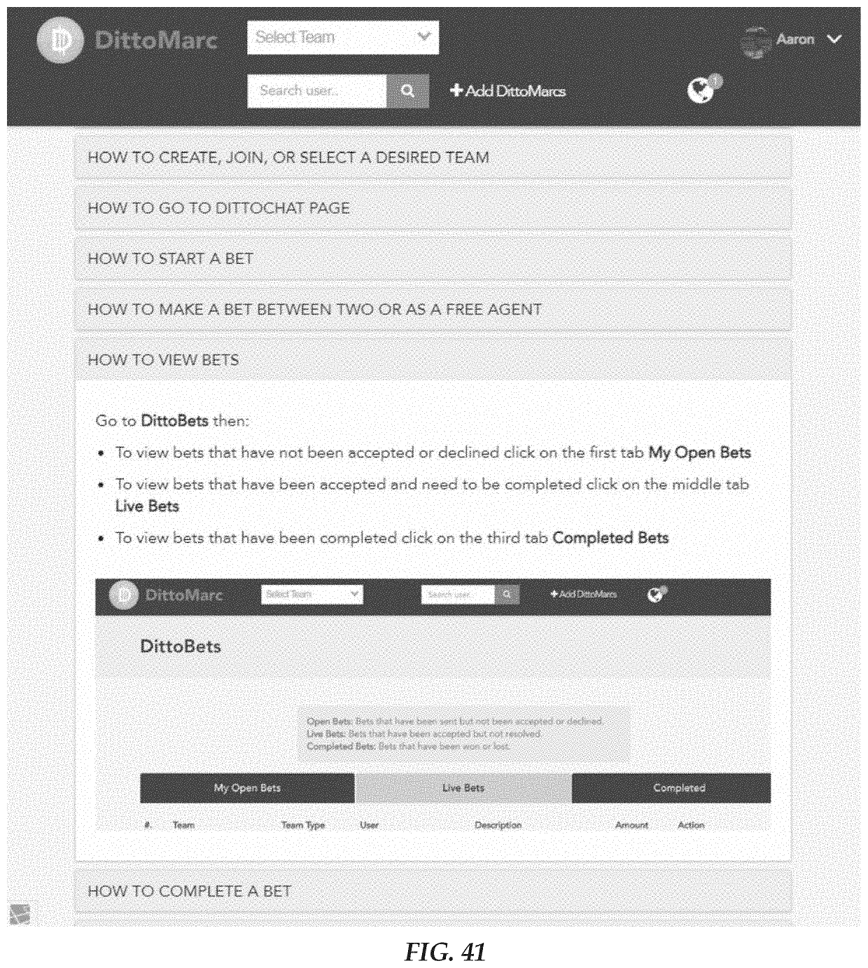

FIG. 42 provides a view of a tutorial for teaching a user how to complete a bet on the presently disclose platform;

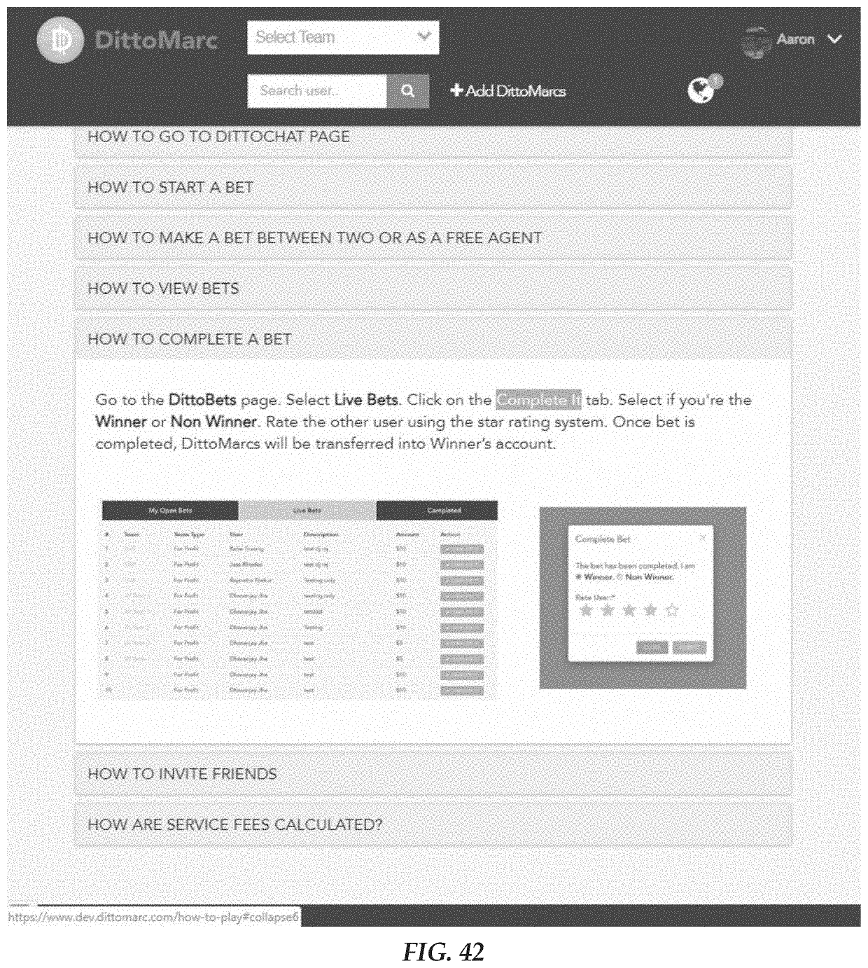

FIG. 43 provides a view of a tutorial for teaching a participant how to invite friends into the DittoMarc™ platform;

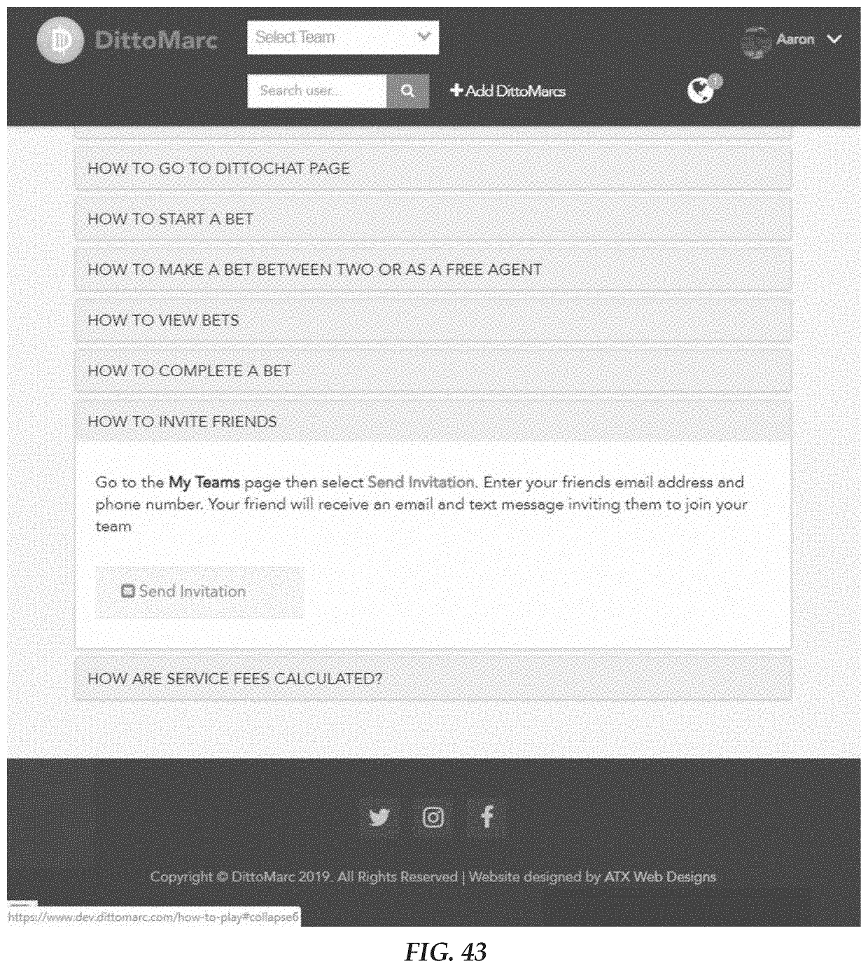

FIG. 44 depicts a potential template for teaching a participant how related service fees may be calculated on the DittoMarc™ platform;

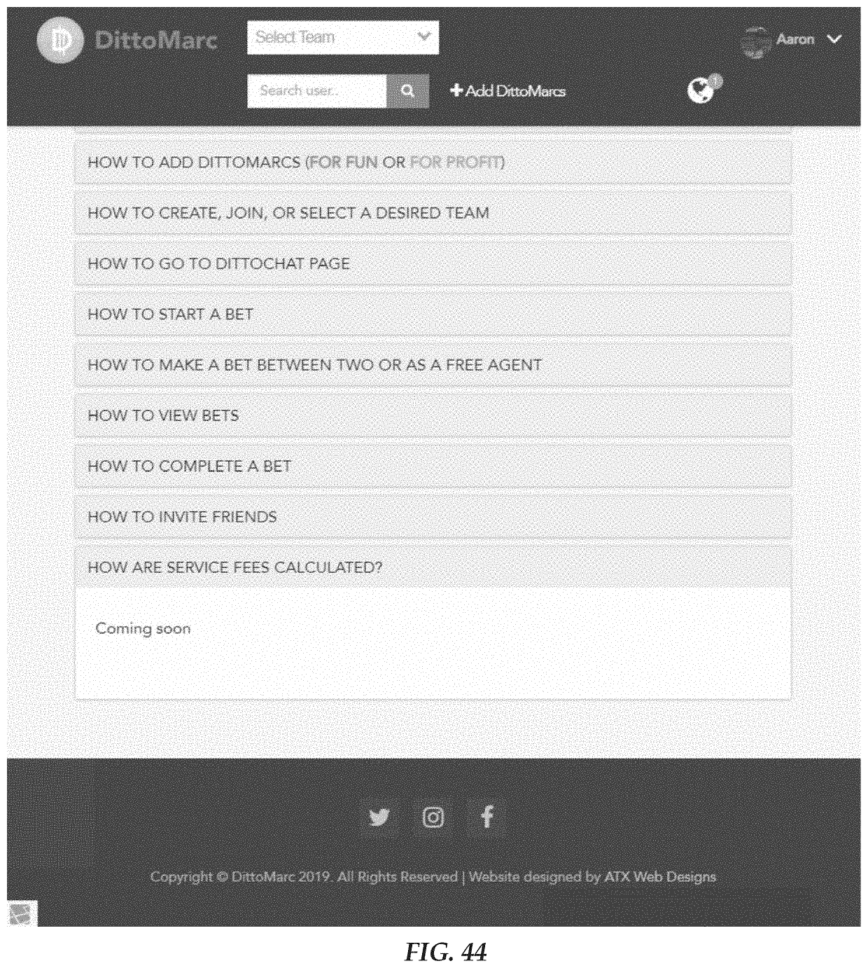

FIG. 45 discloses a user interface for use in allowing the participant to communicate directly to the system operators for use for the DittoMarc™ platform;

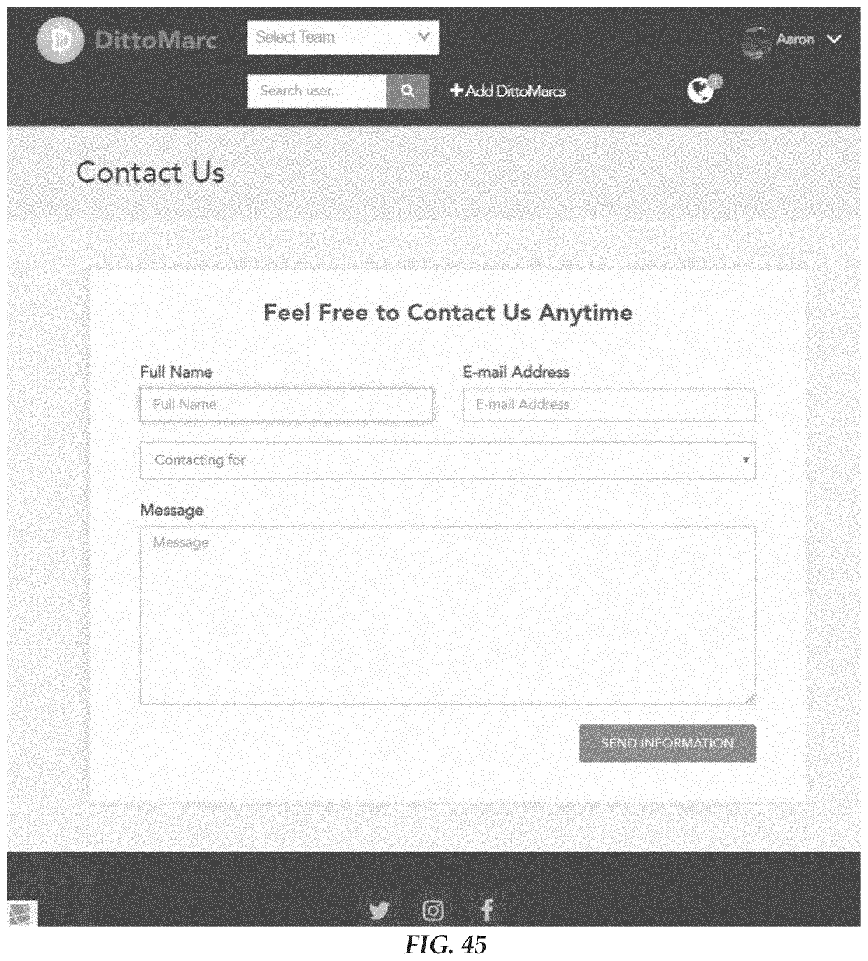

FIG. 46 illustrates a template for allowing a user to change a password in the DittoMarc™ platform; and

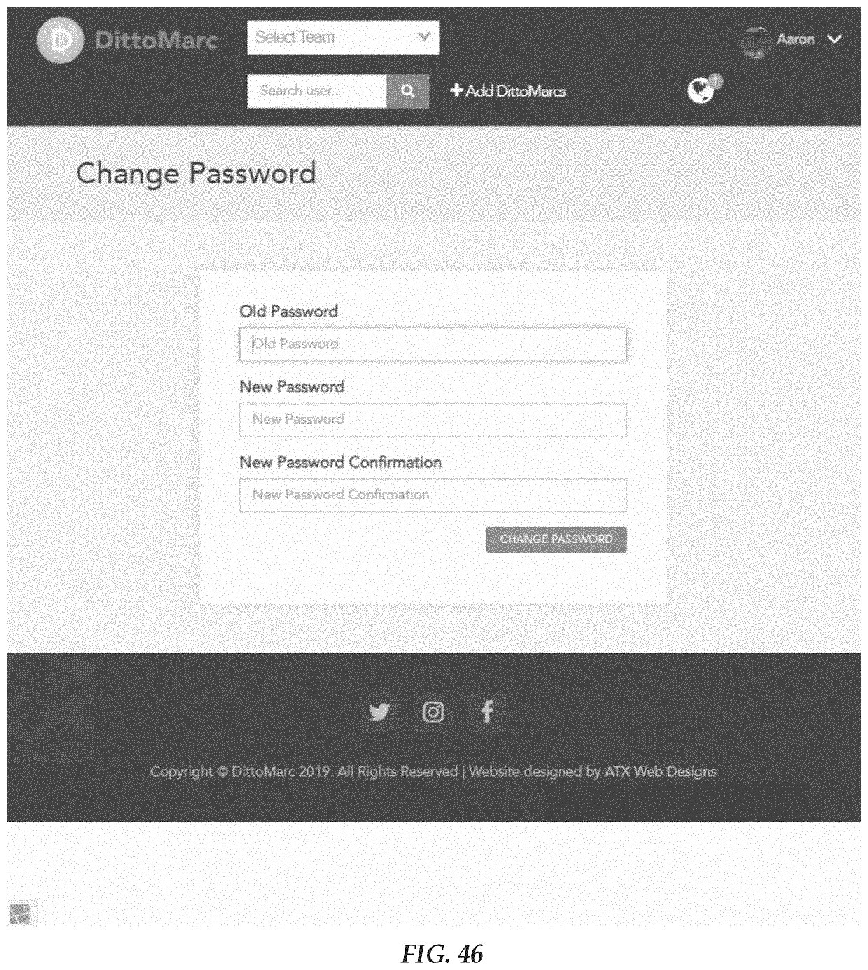

FIG. 47 shows a user interface for allowing the potential participant of the platform of the present invention a bonus to sign up.

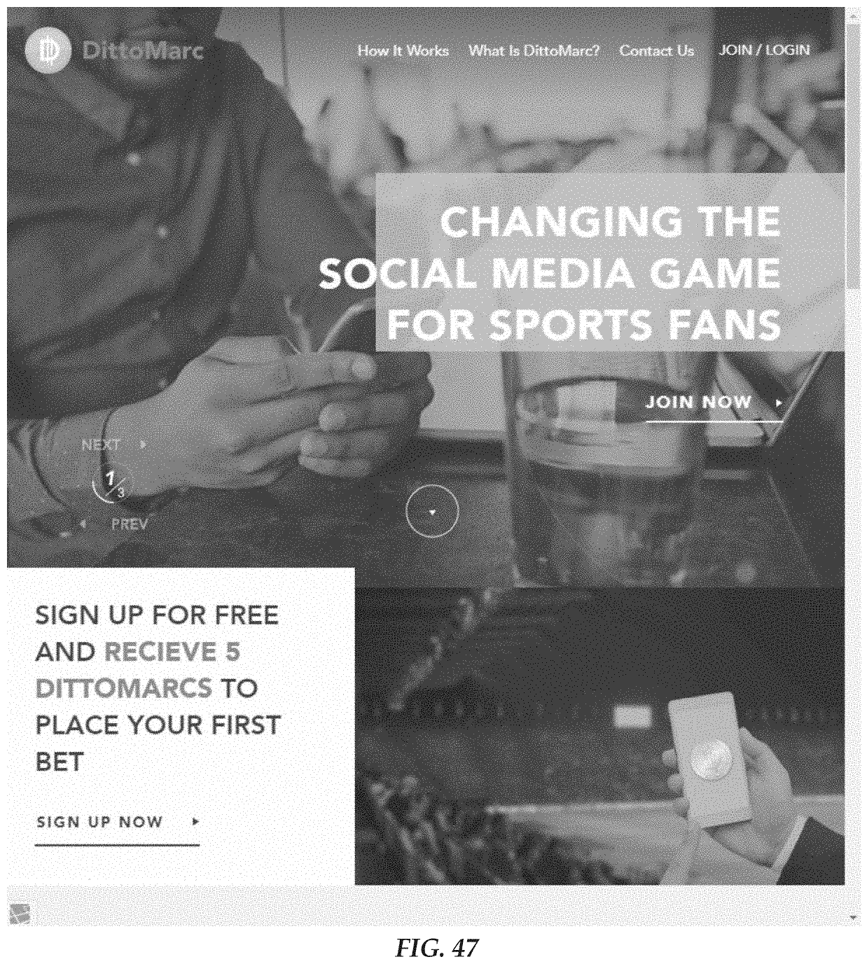

FIG. 48 depicts a screenshot of the platform of the present invention running on a mobile device, showing a rating selection screen.

### DETAILED DESCRIPTION OF THE PREFERRED EMBODIMENTS OF THE PRESENT INVENTION

Reference now should be made to the drawings, in which the same reference numbers are used throughout the different FIGUREs to designate the same components.

The terminology used herein is for the purpose of describing particular embodiments only and is not intended to be limiting. As used herein, the singular forms “a”, “an”, and “the” are intended to include the plural forms as well, unless the context clearly indicates otherwise. It may be further understood that the terms “comprises” and/or “comprising” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Although described with reference to personal computers and the Internet, one skilled in the art could apply the principles discussed herein to any computing or mobile computing environment. Further, one skilled in the art could apply the principles discussed herein to communication mediums beyond the Internet.

It will be appreciated that for simplicity and clarity of illustration, where considered appropriate, reference numerals may be repeated among the FIGUREs to indicate corresponding or analogous elements. In addition, numerous specific details are set forth in order to provide a thorough understanding of the implementations described herein. However, it will be understood by those of ordinary skill in the art that the implementations described herein may be practiced without these specific details.

In other instances, well-known methods, procedures and components have not been described in detail so as not to obscure the implementations described herein. Also, the description is not to be considered as limiting the scope of the implementations described herein.

The following description is intended to show the reader various aspects of this application. With background information to better understand the various aspect of present disclosure. It should be understood that these statements are to be read in this light, and not as admissions of prior art.

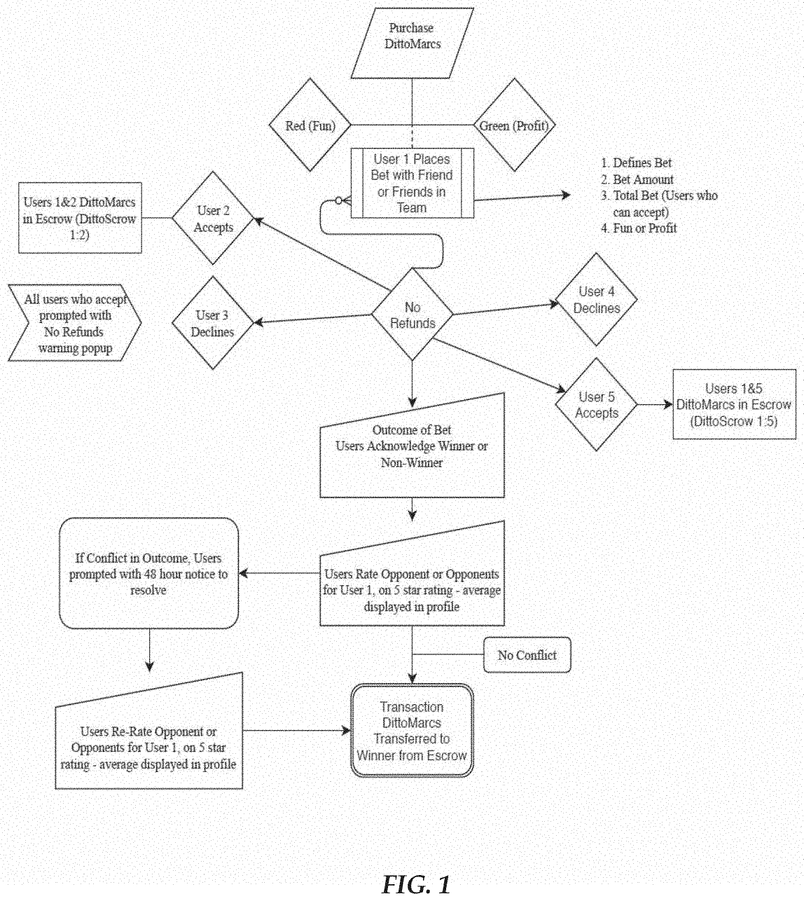

FIG. 1 illustrates a process flow chart for the DittoMarc process of the present disclosure;

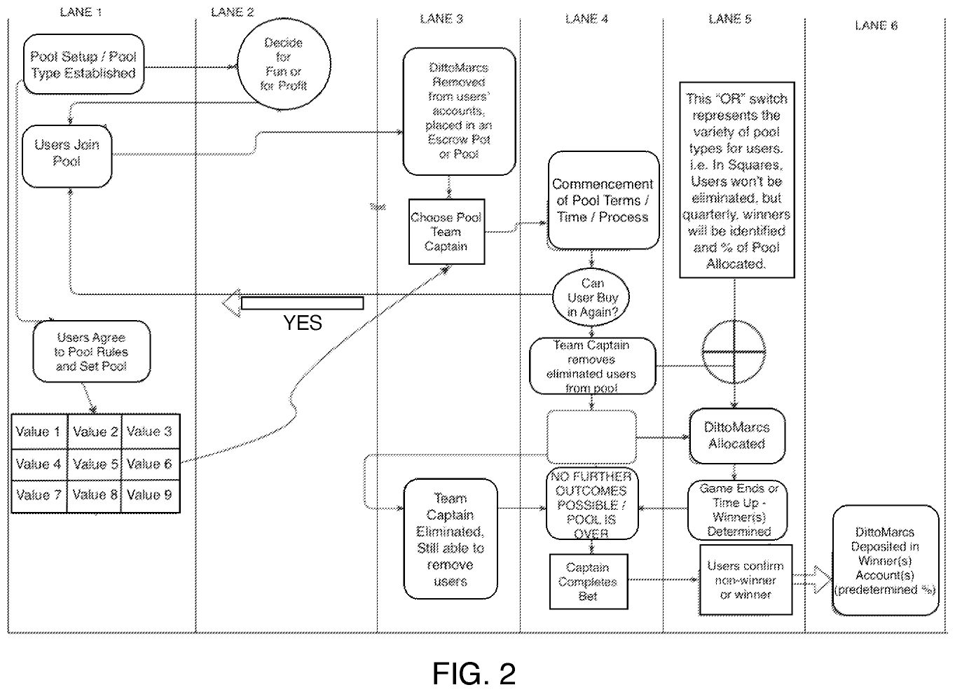

FIG. 2 shows a second flowchart illustrating novel aspects of the present disclosure;

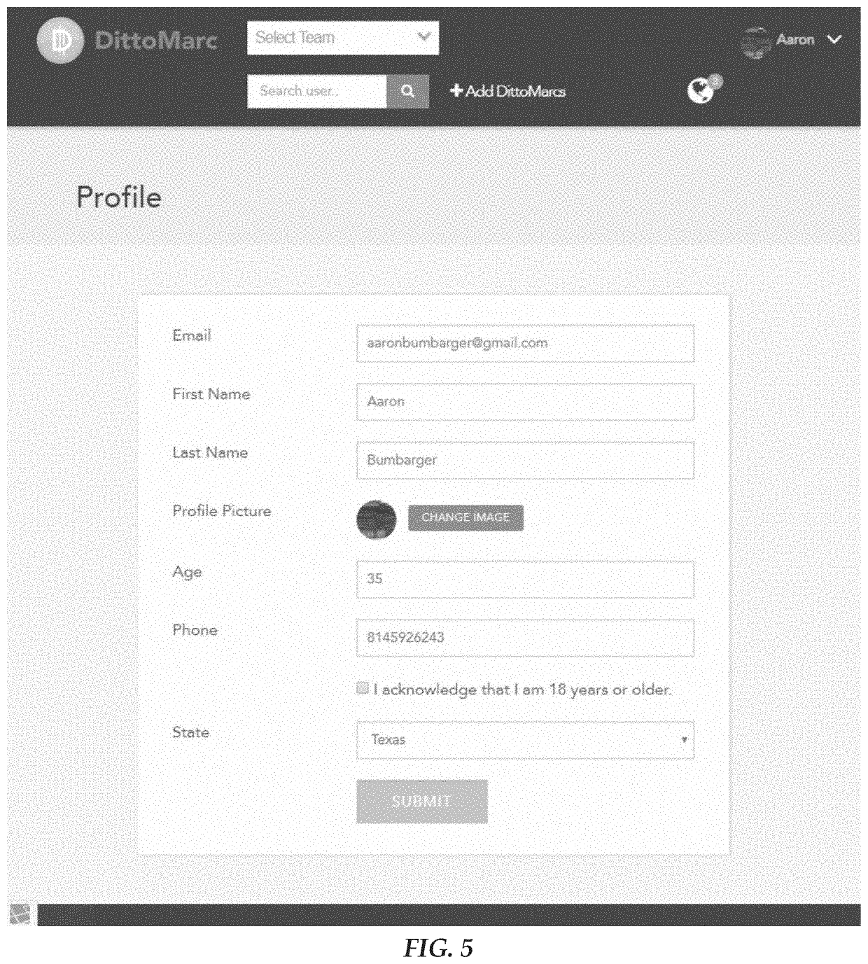

FIG. 5 illustrates a profile template for use by a participant in the DittoMarc platform; DittoMarc is a social media platform for sports fans and video gamers. The product is called a “DittoMarc,” which users can purchase to wager with their friends within the site. Users can purchase Red DittoMarcs, which are “For Fun,” at 10 for $1 plus a service fee. When a user has accumulated enough DittoMarcs for various milestones, they are eligible for prizes. Prizes may range from DittoMarc swag like T-shirts to gift cards.

There is no “cash out” for Red DittoMarcs. Green DittoMarcs are purchased within the site for $1 each plus a service fee per transaction, where all purchased money will be held in an escrow account, and the service fee will be transferred to our bank account. Users may keep a green DittoMarc balance for as long as they choose, or may cash out at any time for an additional service fee.

While users have a balance of DittoMarcs in their profile, they are able to wager the DittoMarcs on anything with their friends. DittoMarc provides the platform to place the wagers, but does not create users' wagers, does not arbitrate the outcomes and does not take any percentage of the bets.

A user could purchase a sum of DittoMarcs one time, and make multiple wagers with their friends before cashing out, and DittoMarc will only be paid the fee on the initial purchase and the cash out, but not on any of the individual bets the user makes with the balance in the account.

Users are not required to maintain a balance in their account to have a profile on DittoMarc, or to build their network of friends on DittoMarc. Users are required to have a balance equal to or greater than the amount of any wager they create in order to execute the wager with their friends. Red and Green DittoMarcs are the only currency users are able to wager on DittoMarc, and are prohibited from using any other form of currency. DittoMarcs are not a crypto currency, and do not carry any value outside of the DittoMarc platform.

DittoPool Description: DittoPool is an umbrella feature on the DittoMarc platform for various “pooled” or “pot” categories of wagering, which could result in a winner take all, or combination of 1st, 2nd, 3rd place etc. Pools can be divided evenly, by dollar amount or by a predetermined percentage established by the members of any particular pool, or by the Captain/Commissioner of the pool.

DittoPool is distinct from regular One-on-One or Team bets on the platform of the present invention, as these bets will be placed in a common Many-to-Many pool system. One-on-One bets are established by the initiator against an individual opponent, and are determined by a binary outcome probability. i.e. “If circumstances of placed bet result in (A) then bet initiator wins; if NOT (A), bet acceptor wins.”

Team bets are structured identically, but in a One-to-Many method. As in the bet above, outcome (A) would be in the initiator's favor, who would consequently win all of the acceptors' wagers, OR if NOT (A), every opponent who accepted the bet will win their portion, and the bet initiator will lose (BetAmount$*#ofAcceptors) up to the “Max Spend” amount.

DittoPool allows for a unique outcome per member of the pool, with options for tie-breakers, thus making it a Many-to-Many bet wherein all members of the pool are competing against everyone else in the pool for a common pot.

### Examples of Dittopools Include the Following:

1. Calendar Pool—in which members wager on a specific time or date to predict an event.

2. Squares—most notably a wagering game where users pre-select squares on a 10×10 grid prior to a sporting event, the rows and columns are then drawn randomly, and the player with the correct square on the coordinate plane that is the cross-section of the ones digit in both teams' score at end of the quarter/half/game wins a predetermined amount.

3. Brackets—Blank or preselected for sporting events, this is for tournament style betting. Could be used for tailgate beer pong tournaments or NCAA Tournament, etc.

4. Survivor League Pools—popular as NFL Survivor League pools, in which members of the pool pick one team per week, and “survive” to the next week if their team wins. Teams cannot be selected by the same member twice, which increases difficulty as losers are removed. This pool is also applicable to other variable laden events—such as politics, contest and reality shows, or TV shows with high turnover.

5. DittoPoker—a virtual escrow for poker games, with other poker related implications and possible applications.

6. Any other Pooled money or elimination format.

### Steps for Forming Dittopools Include These:

1. Users add their names to the numbered list/sign up for pool (1. James, 2. Aaron, 3. Shaun)

2. Users select if they're going to play for Fun or Profit

3. Users purchase their DittoMarcs (Fun or Profit) if they have not already.

4. DittoMarcs will go into a pool/pot instead of individual accounts

5. Users will be able to add additional DittoMarcs to pool/pot as desired/needed to cover “buy backs,” “second chances,” etc.

6. The person who created the pool is the default Captain/Commissioner. If that user declines, other users vote to choose a Team Captain/Commissioner.

7. Role of “Captain” will be separate from the Captain's DittoMarc account, thus allowing the Captain to participate, eliminate, and allocate DittoMarcs to winners at the end, especially if the Captain wins.

8. Team Captain is the only one that will be able to remove other users including himself.

9. Team captain will still be able remove other users even if he is removed from list.

10. All users are removed with the exception of the last player, or the outcome of an event is determined.

11. The team captain Selects “Complete Bet” or Allocates the DittoMarcs by predetermined percentage or dollar amount to the winners.

12. The winner selects “Winner and the Team Captain selects “Non-Winner.”

13. All the DittoMarcs that are in the Pool/Pot will go into the winners' account(s).

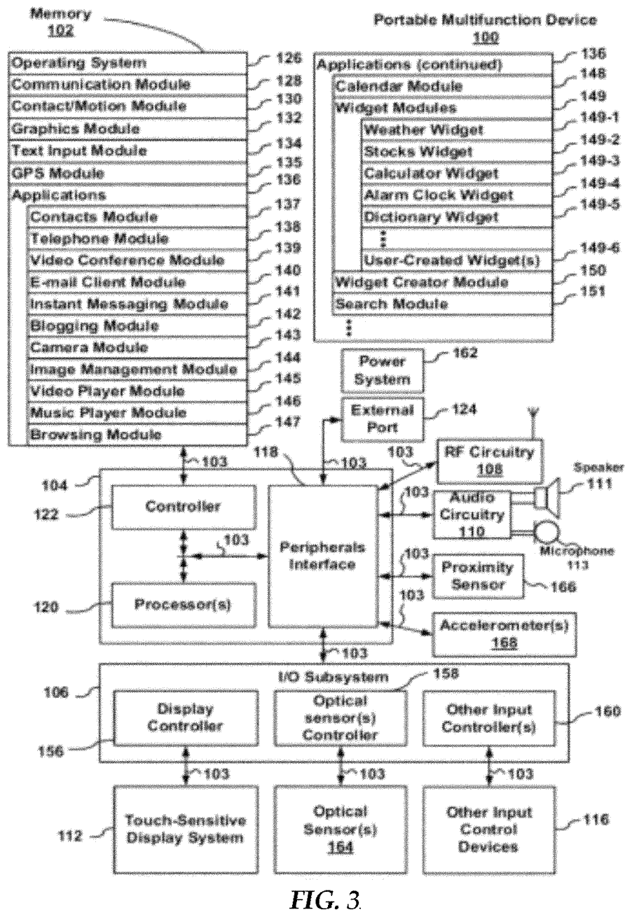

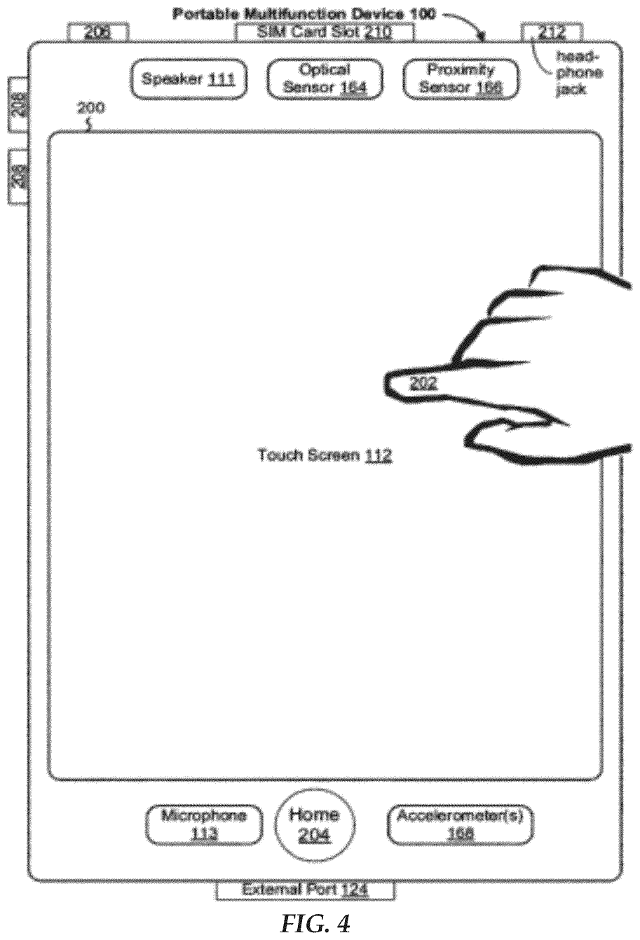

FIGS. 3 and 4 are block diagrams illustrating portable multifunction devices 100 with touch-sensitive displays 112 in accordance with some embodiments for the presently disclosed method, system, and integrated medical imaging system for forming a correlated view of human or other animal anatomy with electromagnetic spectrum images with non-optical electromagnetic images of human or other animal anatomy. The touch-sensitive display 112 is sometimes called a “touch screen” for convenience, and may also be known as or called a touch-sensitive display system. The device 100 may include a memory 102 (which may include one or more computer readable storage mediums), a memory controller 122, one or more processing units (CPU's) 120, a peripherals interface 118, RF circuitry 108, audio circuitry 110, a speaker 111, a microphone 113, an input/output (I/O) subsystem 106, other input or control devices 116, and an external port 124. The device 100 may include one or more optical sensors 164. These components may communicate over one or more communication buses or signal lines 103.

It should be appreciated that the device 100 is only one example of a portable multifunction device 100, and that the device 100 may have more or fewer components than shown, may combine two or more components, or a may have a different configuration or arrangement of the components. The various components shown in FIGS. 3 and 4 may be implemented in hardware, software or a combination of both hardware and software, including one or more signal processing and/or application specific integrated circuits.

Memory 102 may include high-speed random access memory and may also include non-volatile memory, such as one or more magnetic disk storage devices, flash memory devices, or other non-volatile solid-state memory devices. Access to memory 102 by other components of the device 100, such as the CPU 120 and the peripherals interface 118, may be controlled by the memory controller 122.

The peripherals interface 118 couples the input and output peripherals of the device to the CPU 120 and memory 102. The one or more processors 120 run or execute various 001] 5 software programs and/or sets of instructions stored in memory 102 to perform various functions for the device 100 and to process data.

In some embodiments, the peripherals interface 118, the CPU 120, and the memory controller 122 may be implemented on a single chip, such as a chip 104. In some other embodiments, they may be implemented on separate chips.

The RF (radio frequency) circuitry 108 receives and sends RF signals, also called electromagnetic signals. The RF circuitry 108 converts electrical signals to/from electromagnetic signals and communicates with communications networks and other communications devices via the electromagnetic signals. The RF circuitry 108 may include well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth.

The RF circuitry 108 may communicate with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication may use any of a plurality of communications standards, protocols and technologies, including but not limited to Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), and/or Instant Messaging and Presence Service (IMPS)), and/or Short Message Service (SMS)), or any other suitable communication protocol, including communication protocols not yet developed as of the filing date of this document.

The audio circuitry 110, the speaker 111, and the microphone 113 provide an audio interface between a user and the device 100. The audio circuitry 110 receives audio data from the peripherals interface 118, converts the audio data to an electrical signal, and transmits the electrical signal to the speaker 111. The speaker 111 converts the electrical signal to human-audible sound waves. The audio circuitry 110 also receives electrical signals converted by the microphone 113 from sound waves. The audio circuitry 110 converts the electrical signal to audio data and transmits the audio data to the peripherals interface 118 for processing. Audio data may be retrieved from and/or transmitted to memory 102 and/or the RF circuitry 108 by the peripherals interface 118. In some embodiments, the audio circuitry 110 also includes a headset jack (e.g. 212). The headset jack provides an interface between the audio circuitry 110 and removable audio input/output peripherals, such as output-only headphones or a headset with both output (e.g., a headphone for one or both ears) and input (e.g., a microphone). The I/O subsystem 106 couples input/output peripherals on the device 100, such as the touch screen 112 and other input/control devices 116, to the peripherals interface 118. The I/O subsystem 106 may include a display controller 156 and one or more input controllers 160 for other input or control devices. The one or more input controllers 160 receive/send electrical signals from/to other input or control devices 116. The other input/control devices 116 may include physical buttons e.g., push buttons, rocker buttons, etc.), dials, slider switches, joysticks, click wheels, and so forth. In some alternate embodiments, input controller(s) 160 may be coupled to any (or none) of the following: a keyboard, infrared port, USB port, and a pointer device such as a mouse. The one or more buttons (e.g., 208, FIG. 4) may include an up/down button for volume control of the speaker 111 and/or the microphone 113. The one or more buttons may include a push button (e.g., 206, FIG. 4). A quick press of the push button may disengage a lock of the touch screen 112 or begin a process that uses gestures on the touch screen to unlock the device, as described in U.S. patent application Ser. No. 11/322,549, “Unlocking a Device by Performing Gestures on an Unlock Image,” filed Dec. 23, 2005, which is hereby incorporated by reference in its entirety. A longer press of the push button (e.g., 206) may turn power to the device 100 on or off. The user may be able to customize a functionality of one or more of the buttons. The touch screen 112 is used to implement virtual or soft buttons and one or more soft keyboards.

The touch-sensitive touch screen 112 provides an input interface and an output interface between the device and a user. The display controller 156 receives and/or sends electrical signals from/to the touch screen 112. The touch screen 112 displays visual output to the user. The visual output may include graphics, text, icons, video, and any combination thereof (collectively termed “graphics”). In some embodiments, some or all of the visual output may correspond to user-interface objects, further details of which are described below.

A touch screen 112 has a touch-sensitive surface, sensor or set of sensors that accepts input from the user based on haptic and/or tactile contact. The touch screen 112 and the display controller 156 (along with any associated modules and/or sets of instructions in memory 102) detect contact and any movement or breaking of the contact) on the touch screen 112 and converts the detected contact into interaction with user-interface objects (e.g., one or more soft keys, icons, web pages or images) that are displayed on the touch screen. In an exemplary embodiment, a point of contact between a touch screen 112 and the user corresponds to a finger of the user.

The touch screen 112 may use LCD (liquid crystal display) technology, or LPD (light emitting polymer display) technology, although other display technologies may be used in other embodiments. The touch screen 112 and the display controller 156 may detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with a touch screen 112.

A touch-sensitive display in some embodiments of the touch screen 112 may be analogous to the multi-touch sensitive tablets described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in their entirety. However, a touch screen 112 displays visual output from the portable device 100, whereas touch sensitive tablets do not provide visual output.

A touch-sensitive display in some embodiments of the touch screen 112 may be as described in the following applications:
(1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

The touch screen 112 may have a resolution in excess of 100 dpi. In an exemplary embodiment, the touch screen has a resolution of approximately 160 dpi. The user may make contact with the touch screen 112 using any suitable object or appendage, such as a stylus, a finger, and so forth. In some embodiments, the user interface is designed to work primarily with finger-based contacts and gestures, which are much less precise than stylus-based input due to the larger area of contact of a finger on the touch screen.

In some embodiments, the device translates the rough finger-based input into a precise pointer/cursor position or command for performing the actions desired by the user.

In some embodiments, in addition to the touch screen, the device 100 may include a touchpad (not shown) for activating or deactivating particular functions. In some embodiments, the touchpad is a touch-sensitive area of the device that, unlike the touch screen, does not display visual output. The touchpad may be a touch-sensitive surface that is separate from the touch screen 112 or an extension of the touch-sensitive surface formed by the touch screen.

The device 100 also includes a power system 162 for powering the various components. The power system 162 may include a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

The device 100 may also include one or more optical sensors 164. FIG. 3 shows an optical sensor coupled to an optical sensor controller 158 in I/O subsystem 106. The optical sensor 164 may include charge-coupled device (CCD) or complementary metal-oxide semiconductor (CMOS) phototransistors. The optical sensor 164 receives light from the environment, projected through one or more lens, and converts the light to data representing an image. In conjunction with an imaging module 143 (also called a camera module), the optical sensor 164 may capture still images or video. In some embodiments, an optical sensor is located on the back of the device 100, opposite the touch screen display 112 on the front of the device, so that the touch screen display may be used as a viewfinder for either still and/or video image acquisition.

In some embodiments, an optical sensor is located on the front of the device so that the user's image may be obtained for videoconferencing while the user views the other video conference participants on the touch screen display. In some embodiments, the position of the optical sensor 164 can be changed by the user (e.g., by rotating the lens and the sensor in the device housing) so that a single optical sensor 164 may be used along with the touch screen display for both video conferencing and still and/or video image acquisition.

The device 100 may also include one or more proximity sensors 166. FIGS. 3 and 4 show a proximity sensor 166 coupled to the peripherals interface 118. Alternately, the proximity sensor 166 may be coupled to an input controller 160 in the I/O subsystem 106. The proximity sensor 166 may perform as described in U.S. patent application Ser. No. 11/241,839, “Proximity Detector In Handheld Device,” filed Sep. 30, 2005; Ser. No. 11/240,788, “Proximity Detector In Handheld Device,” filed Sep. 30, 2005; Ser. No. 11/620,702, “Using Ambient Light Sensor To Augment Proximity Sensor Output”; Ser. No. 11/586,862, “Automated Response To And Sensing Of User Activity In Portable Devices,” filed Oct. 24, 2006; and Ser. No. 11/638,251, “Methods And Systems For Automatic Configuration Of Peripherals,” which are hereby incorporated by reference in their entirety. In some embodiments, the proximity sensor turns off and disables the touch screen 112 when the multifunction device is placed near the user's ear (e.g., when the user is making a phone call). In some embodiments, the proximity sensor keeps the screen off when the device is in the user's pocket, purse, or other dark area to prevent unnecessary battery drainage when the device is a locked state.

The device 100 may also include one or more accelerometers 168. FIGS. 3 and 4 show an accelerometer 168 coupled to the peripherals interface 118. Alternately, the accelerometer 168 may be coupled to an input controller 160 in the I/O subsystem 106. The accelerometer 168 may perform as described in U.S. Patent Publication No. 20050190059, “Acceleration-based Theft Detection System for Portable Electronic Devices,” and U.S. Patent Publication No. 0060017692, “Methods And Apparatuses For Operating A Portable Device Based On An Accelerometer,” both of which are which are incorporated by reference in their entirety. In some embodiments, information is displayed on the touch screen display in a portrait view or a landscape view based on an analysis of data received from the one or more accelerometers.

In some embodiments, the software components stored in memory 102 may include an operating system 126, a communication module (or set of instructions) 128, a contact/motion module (or set of instructions) 130, a graphics module (or set of instructions) 132, a text input module (or set of instructions) 134, a Global Positioning System (GPS) module (or set of instructions) 135, and applications (or set of instructions) 136.

The operating system 126 (e.g., Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

The communication module 128 facilitates communication with other devices over one or more external ports 124 and also includes various software components for handling data received by the RF circuitry 108 and/or the external port 124. The external port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used on iPod (trademark of Apple Computer, Inc.) devices.

The contact/motion module 130 may detect contact with the touch screen 112 (in conjunction with the display controller 156) and other touch sensitive devices (e.g., a touchpad or physical click wheel). The contact/motion module 130 includes various software components for performing various operations related to detection of contact, such as determining if contact has occurred, determining if there is movement of the contact and tracking the movement across the touch screen 112, and determining if the contact has been broken (i.e., if the contact has ceased).

Determining movement of the point of contact may include determining speed (magnitude), velocity (magnitude and direction), and/or an acceleration (a change in magnitude and/or direction) of the point of contact. These operations may be applied to single contacts (e.g., one finger contacts) or to multiple simultaneous contacts (e.g., “multitouch”/multiple finger contacts). In some embodiments, the contact/motion module 130 and the display controller 156 also detects contact on a touchpad. In some embodiments, the contact/motion module 130 and the controller 160 detects contact on a click wheel.

The graphics module 132 includes various known software components for rendering and displaying graphics on the touch screen 112, including components for changing the intensity of graphics that are displayed. As used herein, the term “graphics” includes any object that can be displayed to a user, including without limitation text, web pages, icons (such as user-interface objects including soft keys), digital images, videos, animations and the like. An animation in this context is a display of a sequence of images that gives the appearance of movement, and informs the user of an action that has been performed (such as moving an email message to a folder). In this context, a respective animation that confirms an action by the user of the device typically takes a predefined, finite amount of time, such as an amount of time between 0.2 and 1.0 seconds, or between 0.5 and 2.0 seconds, depending on the context.

The text input module 134, which may be a component of graphics module 132, provides soft keyboards for entering text in various applications (e.g., contacts 137, e-001] 5 mail 140, IM 141, blogging 142, browser 147, and any other application that needs text input).

The GPS module 135 determines the location of the device and provides this information for use in various applications (e.g., to telephone 138 for use in location-based dialing, to camera 143 and/or blogger 142 as picture/video metadata, and to applications that provide location-based services such as weather widgets, local yellow page widgets, and map/navigation widgets).

The applications 136 may include the following modules (or sets of instructions), or a subset or superset thereof:

a contacts module 137 (sometimes called an address book or contact list);

a telephone module 138;

a video conferencing module 139;

an e-mail client module 140;

an instant messaging (IM) module 141;

a blogging module 142;

a camera module 143 for still and/or video images;

an image management module 144;

a video player module 145;

a music player module 146;

a browser module 147;

a calendar module 148;

widget modules 149, which may include weather widget 149-1, stocks widget 149-2, calculator widget 149-3, alarm clock widget 149-4, dictionary widget 149-5, and other widgets obtained by the user, as well as user-created widgets 149-6;

widget creator module 150 for making user-created widgets 149-6;

search module 151;

video and music player module 152, which merges video player module 145 and music player module 146;

notes module 153; and/or

map module 154.

Examples of other applications 136 that may be stored in memory 102 include other word processing applications, JAVA-enabled applications, encryption, digital rights management, voice recognition, and voice replication.

In conjunction with touch screen 112, display controller 156, contact module 130, graphics module 132, and text input module 134, the contacts module 137 may be used to manage an address book or contact list, including: adding name(s) to the address book; deleting name(s) from the address book; associating telephone number(s), e-mail address(es), physical address(es) or other information with a name; associating an image with a name; categorizing and sorting names; providing telephone numbers or email addresses to initiate and/or facilitate communications by telephone 138, video conference 139, e-mail 140, or IM 141; and so forth. Embodiments of user interfaces and associated processes using contacts module 137 are described further below.

In conjunction with RF circuitry 108, audio circuitry 110, speaker 111, microphone 113, touch screen 112, display controller 156, contact module 130, graphics module 132, and text input module 134, the telephone module 138 may be used to enter a sequence of characters corresponding to a telephone number, access one or more telephone numbers in the address book 137, modify a telephone number that has been entered, dial a respective telephone number, conduct a conversation and disconnect or hang up when the conversation is completed. As noted above, the wireless communication may use any of a plurality of communications standards, protocols and technologies. Embodiments of user interfaces and associated processes using telephone module 138 are described further below.

In conjunction with RF circuitry 108, audio circuitry 110, speaker 111, microphone 113, touch screen 112, display controller 156, optical sensor 164, optical sensor controller 158, contact module 130, graphics module 132, text input module 134, contact list 137, and telephone module 138, the videoconferencing module 139 may be used to initiate, conduct, and terminate a video conference between a user and one or more other participants.

In conjunction with RF circuitry 108, touch screen 112, display controller 156, contact module 130, graphics module 132, and text input module 134, the e-mail client module 140 may be used to create, send, receive, and manage e-mail. In conjunction with image management module 144, the e-mail module 140 makes it very easy to create and send e-mails with still or video images taken with camera module 143. Embodiments of user interfaces and associated processes using e-mail module 140 are described further below.

In conjunction with RF circuitry 108, touch screen 112, display controller 156, contact module 130, graphics module 132, and text input module 134, the instant messaging module 141 may be used to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages and to view received instant messages. In some embodiments, transmitted and/or received instant messages may include graphics, photos, audio files, video files and/or other attachments as are supported in a MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS). Embodiments of user interfaces and associated processes using instant messaging module 141 are described further below.

In conjunction with RF circuitry 108, touch screen 112, display controller 156, contact module 130, graphics module 132, text input module 134, image management module 144, and browsing module 147, the blogging module 142 may be used to send text, still images, video, and/or other graphics to a blog (e.g., the user's blog).

In conjunction with touch screen 112, display controller 156, optical sensor(s) 164, optical sensor controller 158, contact module 130, graphics module 132, and image management module 144, the camera module 143 may be used to capture still images or video (including a video stream) and store them into memory 102, modify characteristics of a still image or video, or delete a still image or video from memory 102. Embodiments of user interfaces and associated processes using camera module 143 are described further below.

In conjunction with touch screen 112, display controller 156, contact module 130, graphics module 132, text input module 134, and camera module 143, the image management module 144 may be used to arrange, modify or otherwise manipulate, label, delete, present (e.g., in a digital slide show or album), and store still and/or video images. Embodiments of user interfaces and associated processes using image management module 144 are described further below.

In conjunction with touch screen 112, display controller 156, contact module 130, graphics module 132, audio 001] 5 circuitry 110, and speaker 111, the video player module 145 may be used to display, present or otherwise play back videos (e.g., on the touch screen or on an external, connected display via external port 124). Embodiments of user interfaces and associated processes using video player module 145 are described further below.

In conjunction with touch screen 112, display system controller 156, contact module 130, graphics module 132, audio circuitry 110, speaker 111, RF circuitry 108, and browser module 147, the music player module 146 allows the user to download and play back recorded music and other sound files stored in one or more file formats, such as MP3 or AAC files. In some embodiments, the device 100 may include the functionality of an MP3 player, such as an iPod (trademark of Apple Computer, Inc.). Embodiments of user interfaces and associated processes using music player module 146 are described further below.

In conjunction with RF circuitry 108, touch screen 112, display system controller 156, contact module 130, graphics module 132, and text input module 134, the browser module 147 may be used to browse the Internet, including searching, linking to, receiving, and displaying web pages or portions thereof, as well as attachments and other files linked to web pages. Embodiments of user interfaces and associated processes using browser module 147 are described further below.

In conjunction with RF circuitry 108, touch screen 112, display system controller 156, contact module 130, graphics module 132, text input module 134, e-mail module 140, and browser module 147, the calendar module 148 may be used to create, display, modify, and store calendars and data associated with calendars (e.g., calendar entries, to do lists, etc.). Embodiments of user interfaces and associated processes using calendar module 148 are described further below.

In conjunction with RF circuitry 108, touch screen 112, display system controller 156, contact module 130, graphics module 132, text input module 134, and browser module 147, the widget modules 149 are mini-applications that may be downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display system controller 156, contact module 130, graphics module 132, text input module 134, and browser module 147, the widget creator module 150 may be used by a user to create widgets (e.g., turning a user-specified portion of a web page into a widget).

In conjunction with touch screen 112, display system controller 156, contact module 130, graphics module 132, and text input module 134, the search module 151 may be used to search for text, music, sound, image, video, and/or other files in memory 102 that match one or more search criteria (e.g., one or more user-specified search terms).

In conjunction with touch screen 112, display controller 156, contact module 130, graphics module 132, and text input module 134, the notes module 153 may be used to create and manage notes, to do lists, and the like.

In conjunction with RF circuitry 108, touch screen 112, display system controller 156, contact module 130, graphics module 132, text input module 134, GPS module 135, and browser module 147, the map module 154 may be used to receive, display, modify, and store maps and data associated with maps (e.g., driving directions; data on stores and other points of interest at or near a particular location; and other location-based data).

Each of the above identified modules and applications correspond to a set of instructions for performing one or more functions described above. These modules (i.e., sets of instructions) need not be implemented as separate software programs, procedures or modules, and thus various subsets of these modules may be combined or otherwise re-arranged in various embodiments. For example, video player module 145 may be combined with music player module 146 into a single module (e.g., video and music player module 152, FIG. 3). In some embodiments, memory 102 may store a subset of the modules and data structures identified above. Furthermore, memory 102 may store additional modules and data structures not described above.

In some embodiments, the device 100 is a device where operation of a predefined set of functions on the device is performed exclusively through a touch screen 112 and/or a touchpad. By using a touch screen and/or a touchpad as the primary input/control device for operation of the device 100, the number of physical input/control devices (such as push buttons, dials, and the like) on the device 100 may be reduced.

The predefined set of functions that may be performed exclusively through a touch screen and/or a touchpad include navigation between user interfaces. In some embodiments, the touchpad, when touched by the user, navigates the device 100 to a main, home, or root menu from any user interface that may be displayed on the device 100. In such embodiments, the touchpad may be referred to as a “menu button.” In some other embodiments, the menu button may be a physical push button or other physical input/control device instead of a touchpad.

FIG. 4 illustrates a portable multifunction device 100 having a touch screen 112 in accordance with some embodiments. The touch screen may display one or more graphics within user interface (UI) 200. In this embodiment, as well as others described below, a user may select one or more of the graphics by making contact or touching the graphics, for example, with one or more fingers 202 (not drawn to scale in the FIGURE). In some embodiments, selection of one or more graphics occurs when the user breaks contact with the one or more graphics. In some embodiments, the contact may include a gesture, such as one or more taps, one or more swipes (from left to right, right to left, upward and/or downward) and/or a rolling of a finger (from right to left, left to right, upward and/or downward) that has made contact with the device 100. In some embodiments, inadvertent contact with a graphic may not select the graphic. For example, a swipe gesture that sweeps over an application icon may not select the corresponding application when the gesture corresponding to selection is a tap.

The device 100 may also include one or more physical buttons, such as “home” or a menu button 204. As described previously, the menu button 204 may be used to navigate to any application 136 in a set of applications that may be executed on the device 100. Alternatively, in some embodiments, the menu button is implemented as a soft key in a GUI in touch screen 112.

In one embodiment, the device 100 includes a touch screen 112, a menu button 204, a push button 206 for powering the device on/off and locking the device, volume adjustment button(s) 208, a Subscriber Identity Module (SIM) card slot 210, a head set jack 212, and a docking/charging external port 124. The push button 206 may be used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, the device 100 also may accept verbal input for activation or deactivation of some functions through the microphone 113.

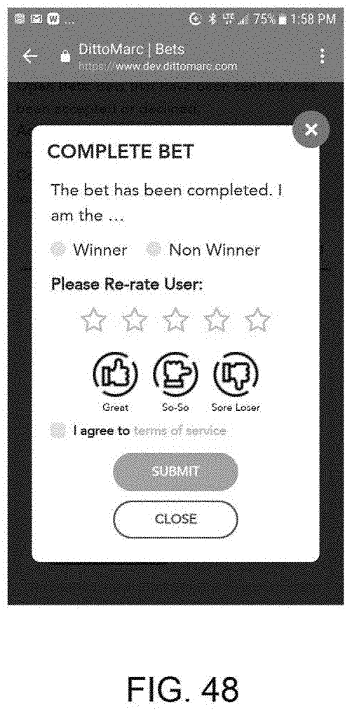

It should be noted that the system and platform of the present invention facilitates a self-governed betting apparatus configured for use over the interne. The present invention is configured to automatically filter-out users with which the player can actively play with based on a rating system. The rating system is mandatory for winners, and enables them to rate each other based on the accuracy of the declaration of the winner after each wagered event has transpired. In the event that a non-winning player fails to select the true winner of the wager, the winner may then poorly rate the non-winner. With a poor enough rating, the player may no longer participate in the platform, as he or she is automatically filtered-out of any player's requests for a partner, or is removed from the team. Ratings are preferably accomplished via a “star rating” of one to five stars awarded by the winner. Additionally, a rating badge is preferably used to provide an explanation for the rating earned: a thumbs-down badge indicates a “sore loser,” a thumbs-up badge indicates a great and timely transaction, and a “so-so” badge (indicated by a sideways thumb) indicates a middle-ground. Only the winner gets to rate the other user of the wager. If the loser holds up payment, takes a long time to pay, has a problem paying, or other similar issue, the winner can provide a rating of “one star” and a “sore loser” badge to warn other players as shown in FIG. 48. A user's overall rating is an average of all ratings earned.

By the nature of the filtering system of the present invention, cheaters and sore losers effectively eliminate themselves from the platform of the present invention, as most users will opt to filter out other users with low ratings to avoid hassle. Once a user has a rating of over four stars, on average, such as 4.2 stars, the platform will upgrade the user to five stars for the matching algorithm. Similarly, once a user achieves an average rating over three stars, such as 3.3 stars, the user is automatically upgraded to four star status.

Similarly, it should be understood that, in the DittoPool embodiment of the present invention, no single player is provided the opportunity to rate other players, as the admin of the pool is in full control over dictating who the winner was. However, the majority of the DittoPool must agree on the player awarded the admin title.

As outlined above, the platform of the present invention is preferably accessible via a conventional mobile device, computer, tablet computer, or similar internet-connected device as an alternative to a stand-alone device as previously outlined. It is envisioned that the platform be made accessible via a mobile device application as present on the Apple™ App Store™ and/or Google™ Play Store. Further, it should be understood that the platform of the present invention is preferably granted access to the conventionally integrated GPS radio of the mobile device to facilitate location-based searches for players with which the user may wager.

The system of the present invention is preferably configured to enable users to search for fellow players having similar ratings, and may employ a matching feature which will match players together who wish to wager the same (or similar) dollar amounts, referenced as “DittoMatch.” Location-based partnering is preferably defined by the user on a sliding scale, such that the user may opt to search for players within 100 feet, one mile, five-mile radius, etc. This feature employs geo-fencing, facilitated via onboard GPS of the user's mobile device, and/or via cell phone tower triangulation or WiFi triangulation. Geofencing at a state-wide limit is preferably in place by default to limit betters due to the present terms of the Wire-Act law. Without such features provided by the system and platform of the present invention, a player would not be able to know that there are other players nearby, such as in the stands of a football stadium, who wish to bet with the player.

Additionally, it should be noted that all embodiments of the present invention are preferably configured to accept debit and credit card payments, as well as conventional mobile payment mechanisms (PayPal™, Apple Pay™, etc.) to facilitate the purchase of Dittomarcs as in-game currency. Similarly, it should be understood that the system of the present invention is preferably capable of directly interfacing with a banking account in order to facilitate payment of winnings to paying participants on the platform.

Further, it is envisioned that the system and platform of the present invention may be used to conduct distanced games between players to facilitate the betting on personal group sports such as poker. In such instances, the DittoPool embodiment of the present invention is preferably employed such that one player is selected as the dealer. In such events, “DittoPoker” being one, all funds are directed to a single pot, with winner taking all bets upon a verified win by the dealer (admin). Ditto Poker is envisioned to be playable in brackets (including teamed brackets) and pools, as well as other game styles as desired by players.

Teams are preferably established within the platform to maintain a pool of desired players with which the user may play and converse. Pooled betting is available in which a single player, nominated by others in the pool, is given an admin role with the sole discretion to determine the winner of the pool. A “My Teams” portion of the platform of the present invention facilitates view and editing of one's team. Only the user which created the team may add or remove other users to/from the team. Similarly, only the user which created the team may activate the team or delete the team. A team chat page is preferably available to facilitate discussion amongst the team in a group chat.

Additional features of the platform of the present invention include a “Live Trending Games” view, which shows three games of which the user wants to track. Upon selection, the platform will always show the user, upon logging into the platform with his/her username and password, the scores of the games selected. Similarly, a “Live Bets” feature shows the user a list of proximal wagers (bets) which are currently taking place. Users may opt to follow other users, such as if they notice that they are winning often. A “DittoLive” feature of the dashboard of the platform shows live odds and spreads based on imported data from Las Vegas, allowing the user to use the same odds as those employed in casinos for their wagers against other players if desired.

A “DittoOffers” portion of the platform of the present invention is designed to inform the user of wagers that are presently available on the platform which are current and are unfilled. These “offers” are made by other users who are searching for someone to take on their bet. The user may opt to filter bets (based on location, star rating, etc.) which are visible to the user via the DittoOffers feature if desired.

It should be understood that the present invention is a method of employing an online platform for the enactment of wagers and the awarding of winnings, represented as DittoMarc currency. As previously outlined, this method includes:
navigating to the platform via an internet-connected device;
adding funds to an account of the user;
the platform converting the funds into platform currency referenced as DittoMarcs;
the platform executing a search for nearby participants in search of users with which to wager against;
the platform filtering a result set of the search based on one or more locations proximal to the user and based on participant-supplied ratings;
placing a wager against a participant, the wager pertaining to an event of which both the user and the participant are actively aware, the event being one in which a clear winner and loser may be determined and immediately objectively evident upon the completion of the event;
the event concluding, making the winner of the event known;
the platform prompting both wagering participants to indicate a winner of the wager as a selection;
both wagering participants selecting a winner;
the platform confirming that both wagering participants' indicated winner matches;
the platform awarding the user who made the wager on the winner of the event with the wagered DittoMarcs;
the platform prompting the winner to review the participant on a scale of one to five stars;
the platform prompting the winner to award a badge to the loser, the badge being selected from the following group: “great,” “so-so,” and “sore loser;” and
wherein the participant-supplied ratings are only awarded by the winner of the wager.

The benefits and advantages that may be provided by the present invention has been described above with regard to specific embodiments. These benefits and advantages, and any elements or limitations that may cause them to occur or to become more pronounced are not to be construed as critical, required, or essential features of any of any or all of the claims. As used herein, the singular forms “a”, “an”, and “the” are intended to include the plural forms as well, unless the context clearly indicates otherwise.

It is further understood that the terms “comprises” and/or “comprising” or “includes” and/or including”, or any other variation thereof, are intended to be interpreted as nonexclusively including the elements or limitations which follow those terms.

Accordingly, a system, method, or other embodiment that comprises a set of elements is not limited to only those elements, and may include other elements not expressly listed or inherent to the claimed embodiment. These terms when used in this specification, specify the presence of stated features, regions, integers, steps, operations, elements, and/or components, but do not preclude the presence or addition of one or more features, regions, integers, steps, operations, elements, components, and/or groups thereof.

I claim:

1. A method of placing wagers between participants, awarding winners of wagers, and reviewing participants on an internet-based platform by a user comprising:
navigating to the platform via an internet-connected device;
adding funds to an account of the user;
the platform converting the funds into platform currency referenced as DittoMarcs;
the platform executing a search for nearby participants in search of users with which to wager against;
the platform filtering a result set of the search based on locations proximal to the user and based on participant-supplied ratings;
placing a wager against a participant, the wager pertaining to an event of which both the user and the participant are actively aware, the event being one in which a clear winner and loser may be determined and immediately objectively evident upon the completion of the event;
the event concluding, making the winner of the event known;
the platform prompting both wagering participants to indicate a winner of the wager as a selection;
both wagering participants selecting a winner;
the platform confirming that both wagering participants' indicated winner matches; and
the platform awarding the user who made the wager on the winner of the event with the wagered DittoMares.

2. The method of claim 1, further comprising:
the platform prompting the winner to review the participant on a scale of one to five stars; and
the platform prompting the winner to award a badge to the loser, the badge being selected from the following group: “great,” “so-so,” and “sore loser.”

3. The method of claim 2, wherein the participant-supplied ratings are only awarded by the winner of the wager.

4. The method of claim 3, wherein the one or more locations proximal to the user are user-defined in accordance with a physical distance embodied by a radius from the user.
